(19) United States
(12) Patent Application Publication
(10) Pub. No.: US 2010/0104323 A1
(43) Pub. Date: Apr. 29, 2010

(54) TONER, DEVELOPER, DEVELOPING DEVICE AND IMAGE FORMING APPARATUS

(76) Inventors: Kiyoshi Toizumi, Osaka (JP); Katsuru Matsumoto, Osaka (JP); Keiichi Kikawa, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/605,662

(22) Filed: Oct. 26, 2009

(30) Foreign Application Priority Data
Oct. 28, 2008 (JP) 2008-277514

(51) Int. Cl. G03G 15/08; G03G 9/08

(52) U.S. Cl. 399/252; 430/108.7

(57) ABSTRACT

A toner is provided. The toner includes toner particles, and silica particles and inorganic fine particles that are externally added to the toner particles, the inorganic fine particles having an average primary particle size smaller than that of the silica particles. The toner particles have a shape factor SF-1 of 130 or more and 140 or less, a shape factor SF-2 of 120 or more and 130 or less, and a volume average particle size of 5 μm or more and 8 μm or less. The silica particles have an average primary particle size of 80 nm or more and 150 nm or less, and an amount of water of 1.5% by weight or less. A particle size distribution of the silica particles is a logarithmic normal distribution, and a value of geometric standard deviation σ_{g} of the particle size of the silica particles is less than 1.30.

### CROSS-REFERENCE TO RELATED APPLICATION

This application claims priority to Japanese Patent Application No. 2008-277514, which was filed on Oct. 28, 2008, the contents of which are incorporated herein by reference in its entirety.

### BACKGROUND OF THE INVENTION

1. Field of the Invention

The present invention relates to a toner used to develop a latent image in electrophotography or electrostatic printing process, a developer comprising the toner, a developing device using the developer, and an image forming apparatus.

2. Description of the Related Art

In recent years, high image quality is investigated from various angles in an image forming apparatus which forms an image by developing a latent image. Improvement of a developer for the purpose of improving resolving powder and sharpness, particularly, reduction in particle size and nearly spheronization of a toner, is advanced as one of specific trends. However, with the advance of reduction in particle size and nearly spheronization of a toner, transferability and cleanability are decreased, and this tends to incur decrease in image quality.

In order to cope with the above problems, it has been attempted to improve the transferability and cleanability by adding an external additive having a particle size of around 100 nm as spacer onto the surfaces of the toner. However, the function of the spacer cannot be drawn to a sufficient degree unless the particle size and properties of the external additive are controlled.

Regarding the particle size of the external additive, specifically, when the average primary particle size thereof is too small, the spacer effect is not obtained between the toner and the surface of the photoreceptor drum or the transfer belt (inclusive of both the transfer system directly onto the paper or the intermediate transfer belt system), and good cleanability cannot be ensured.

When an average primary particle size of the external additives is too large, decrease in toner specific charge occurs. The following points are considered as the cause of such a phenomenon. When an average primary particle size of the external additives is too large, the number of the external additive particles having a large particle size is increased. As a result, a space between a toner and a carrier becomes too large by such external additives, and a contact failure occurs between a toner and a carrier, resulting in charging defect. Furthermore, when an average primary particle size of the external additives is too large, the amount of the additives dropped out of the toner particles is increased, and as a result, it is considered that chargeability cannot be ensured.

Regarding properties of the external additives, specifically, when a print duration test is conducted using a toner having externally added thereto external additives containing an undesirably large amount of water, toner specific charge is decreased. As a result, the toner scatters in the apparatus, and image quality of an image formed is decreased. The cause is that charge leaks on the surface of a toner through the external additives containing an undesirably large amount of water. This phenomenon is particularly remarkable in the case that the amount of water contained in the external additives exceeds 6.0% by weight.

To solve those problems Japanese Unexamined Patent Publication JP-A 2005-202132 discloses an electrostatic latent image developing toner comprising toner particles comprising a binder resin, a colorant and a release agent, and external additives, wherein the external additives comprise small size particles having a volume average particle size of from 5 nm to 30 nm and large size particles having a volume average particle size of from 100 nm to a particle size of the toner, and the large size particles are surface-treated with a charge control agent. Furthermore, when the volume average particle size of the large size particles is d₅₀, a particle size distribution of the large size particles is such that the proportion of particles falling within a range of from 0.3×d₅₀ to 3×d₅₀ amounts 60% by mass or more, and an average shape factor SF-1 of a toner falls within a range of from 100 to 140. The electrostatic latent image developing toner disclosed in JP-A 2005-202132 has satisfactory toner fluidity, chargeability, developability, transferability, cleanability and fixability at the same time over a long period of time.

However, JP-A 2005-202132 does not consider the amount of water contained in the external additives having a large particle size. In particular, when the external additives having a large particle size containing water in an amount exceeding 6.0% by weight are externally added to the toner, toner specific charge of the toner is decreased in a print duration test. Therefore, image quality of an image formed is decreased, and the problem arises such that the toner scatters in an apparatus. Furthermore, particle size distribution of the external additives having a large particle size is broad. Therefore, when the additive amount of the external additives having a large particle size is increased in order to secure cleaning performance, the number of fine particles having a small particle size (particularly 30 nm or less) is increased, and the surface of toner particle is covered with the fine particles more than necessary. As a result, the effect of oozing the release agent contained in the toner particles is inhibited, and this may adversely affect fixability.

### SUMMARY OF THE INVENTION

An object of the invention is to provide a toner comprising nearly spherical toner particles having a small particle size and external additives externally added thereto, the toner being capable of securing cleaning performance and fixability and suppressing decrease in toner specific charge in a print duration test, a developer comprising the toner, a developing device capable of suppressing decrease in image quality of a printed image by using the developer and reducing scatter of the toner, and an image forming apparatus.

The invention provides a toner comprising toner particles, and silica particles and inorganic fine particles that are externally added to the toner particles, the inorganic fine particles having an average primary particle size smaller than that of the silica particles,

the toner particles having a shape factor SF-1 of 130 or more and 140 or less, a shape factor SF-2 of 120 or more and 130 or less, and a volume average particle size of 5 μm or more and 8 μm or less;

the silica particles having an average primary particle size of 80 nm or more and 150 nm or less, and the amount of water of 1.5% by weight or less; and

a particle size distribution of the silica particles being a logarithmic normal distribution, and a value of geometric standard deviation σ_{g} of the particle size of the silica particles being less than 1.30.

According to the invention, the toner comprises toner particles, and silica particles and inorganic fine particles that are externally added to the toner particles, the inorganic fine particles having an average primary particle size smaller than that of the silica particles. The toner particles have a shape factor SF-1 of 130 or more and 140 or less, and a shape factor SF-2 of 120 or more and 130 or less, and the silica particles have an average primary particle size of 80 nm or more and 150 nm or less, and the amount of water of 1.5% by weight or less.

When the shape factor SF-1 of the toner particles is less than 130, the toner particle shape is close to a perfect spherical shape. Therefore, even though silica particles having a large particle size in which an average primary particle size is 80 nm or more and 150 nm or less are externally added, cleaning performance cannot be improved. When the shape factor SF-1 of the toner particles exceeds 140, because the toner particles originally have irregular shapes, even though silica particles having a large particle size in which an average primary particle size of 80 nm or more and 150 nm or less are externally added, further improvement effect of the cleaning performance is not obtained. Furthermore, transfer efficiency is decreased.

When the shape factor SF-2 of the toner particles is less than 120, irregularities on the surface of toner particles are too small. Therefore, adhesion of silica particles having a large particle size in which an average primary particle size of 80 nm or more and 150 nm or less to the toner particles is decreased, and cleaning performance cannot be improved. When the shape factor SF-2 of the toner particles exceeds 130, the silica particles having a large particle size in which an average primary particle size of 80 nm or more and 150 nm or less enter the depressed portions on the surface of the toner particles, and spacer effect of the silica particles having a large particle size is not exhibited, resulting in decrease in transfer efficiency.

When the average primary particle size of the silica particles is less than 80 nm, cleaning performance is not obtained. Additionally, the number of silica particles having a small particle size of 30 nm or less is increased, the surface of the toner particles is covered with the particles more than necessary, and the effect of oozing a release agent contained in the toner particles is inhibited, resulting in deterioration of fixability. When the average primary particle size of the silica particles exceeds 150 nm, a space between the toner and the carrier becomes too large. As a result, contact failure between the toner and the carrier is generated, resulting in decrease in toner specific charge.

When the amount of water in the silica particles exceeds 1.5% by weight, electric charges charged on the surface of a toner particle leak through the silica particles, resulting in decrease in toner specific charge.

When silica particles having an average primary particle size of 80 nm or more and 150 nm or less and the amount of water of 1.5% by weight or less are externally added to toner particles having the shape factor SF-1 of 130 or more and 140 or less and the shape factor SF-2 of 120 or more and 130 or less, cleaning performance to a photoreceptor drum and a transfer belt can be secured, and decrease in toner specific charge in a print duration test can be suppressed. Formation of an image using such a toner can suppress increase in image quality of a printed image and can reduce scatter of toner in an apparatus.

Furthermore, when the silica particles having an average primary particle size of 80 nm or more and 150 nm or less and inorganic fine particles having an average primary particle size smaller than that of the silica particles are externally added in combination, mixability between the toner particles and the silica particles is improved at the external addition treatment, and the silica particles are uniformly dispersed on the surface of the toner particles. As a result, fluidity of the toner can be secured and rising of toner charging can be fastened. Unless the silica particles having an average primary particle size of 80 nm or more and 150 nm or less and inorganic fine particles having an average primary particle size smaller than that of the silica particles are added in combination, the silica particles cannot uniformly be dispersed on the surface of the toner particles, and fluidity of a toner cannot be secured. As a result, a toner that can be applied to performance verification cannot be obtained.

Furthermore, a particle size distribution of the silica particles is a logarithmic normal distribution, and a value of geometric standard deviation σ_{g} of a particle size of the silica particles is less than 1.30. The geometric standard deviation (σ_{g}) of a particle size of the silica particles is obtained by dividing an average particle size of the silica particles by 15.87% particle size integrally sieved, or dividing 84.13% particle size integrally sieved by an average particle size of the silica particles. When a value of geometric standard deviation σ_{g} of a particle size of the silica particles is less than 1.30, the number between silica particles having a large particle size and silica particles having a small particle size in a particle size distribution of the silica particles can appropriately be adjusted, and as a result, decrease in toner specific charge by contact failure between a toner and a carrier can be suppressed. Furthermore, decrease in fixability by silica particles of 30 nm or less can be suppressed. Therefore, cleaning performance to a photoreceptor drum and a transfer belt can stably be secured and decrease in toner specific charge in a print duration test can further be suppressed.

A volume average particle size of the toner particles is 5 μm or more and 8 μm or less. When the volume average particle size of the toner particles is less than 5 μm, a particle size is too small, and even though silica particles having a large particle size in which an average primary particle size of 80 nm or more and 150 nm or less are externally added, cleaning performance cannot be secured. When the volume average particle size of the toner particles exceeds 8 μm, a particle size is too large, and even though silica particles having a large particle size in which an average primary particle size of 80 nm or more and 150 nm or less are externally added, further improvement effect of cleaning performance cannot be obtained. Furthermore, image quality is decreased. When the volume average particle size of the toner particles is 5 μm or more and 8 μm or less, an image having high image quality can be formed, and cleaning performance can be secured.

Furthermore, in the invention, it is preferable that the silica particles are subjected to hydrophobization treatment.

According to the invention, the silica particles are subjected to hydrophobization treatment. The hydrophobization treatment can reduce change in toner specific charge between high temperature and high humidity environment and low temperature and low humidity environment. Therefore, cleaning performance to a photoreceptor drum and a transfer belt can stably be secured and decrease in toner specific charge in a print duration test can be suppressed, regardless of humidity.

Furthermore, in the invention, it is preferable that the silica particle has a specific surface area of 30 m²/g or more and 55 m²/g or less.

According to the invention, a specific surface area of the silica particle is 30 m²/g or more and 55 m²/g or less. When the specific surface area is less than 30 m²/g, the number of silica particles having a large particle size is increased, and a space between a toner and a carrier becomes too large by the particles. As a result, contact failure between a toner and a carrier is generated, resulting in decreased in toner specific discharge. When the specific area exceeds 55 m²/g, the number of silica particles having a small particle size is increased, the surface of the toner particles is covered with the particles more than necessary, and the effect of oozing a release agent contained in the toner particles is inhibited, resulting in decrease in toner fixability. When the specific surface area of the silica particle is from 30 m²/g to 55 m²/g, decrease in toner specific discharge in a print duration test can further be suppressed. Furthermore, the number of silica particles having a small particle size can be reduced, and as a result, fixability can be secured.

Furthermore, in the invention, it is preferable that the silica particles are externally added in a proportion of 0.5 part by weight or more and 3.0 parts by weight or less based on 100 parts by weight of the toner particles.

According to the invention, the silica particles are externally added in a proportion of 0.5 part by weight or more and 3.0 parts by weight or less based on 100 parts of the toner particles. When the proportion of the silica particles externally added is less than 0.5 part by weight based on 100 parts of the toner particles, cleaning performance of the toner cannot be secured. When the proportion of the silica particles externally added exceeds 3.0 parts by weight based on 100 parts by weight of the toner particles, the silica particles are easily separated from the toner particles, and a toner is adhered to the surface of a carrier in the case of a two-component developer. Therefore, the toner specific discharge is decreased in the print duration test, resulting in decrease in image quality of a printed image and scatter of a toner in an apparatus. When the silica particles are externally added in a proportion of 0.5 part by weight or more and 3.0 parts by weight or less based on 100 parts of the toner particles, cleaning performance of the toner can be secured and decrease in toner specific discharge in the print duration test can further be suppressed.

Furthermore, the invention provides a developer comprising the toner mentioned above.

According to the invention, the developer comprises the toner mentioned above. This can establish both of good cleanability and fixability, and can achieve a developer that can suppress decrease in toner specific discharge in the print duration test.

Furthermore, in the invention, it is preferable that the developer further comprises a carrier and constitutes a two-component developer.

According to the invention, the developer is a two-component developer comprising the toner of the invention and a carrier. The toner of the invention can establish both of good cleanability and fixability, and can suppress decrease in toner specific discharge in the print duration test. Therefore, a two-component developer having good charging characteristics and developability is obtained. Use of such two-component developer can suppress decrease in image quality due to scatter of the toner in the apparatus and can stably form an image having high image quality.

The invention provides a developing device which carries out development using the developer mentioned above.

According to the invention, the developing device develops a latent image using the developer of the invention. Therefore, a toner image having high definition and high resolution can stably be formed on a photoreceptor without causing development defect due to decrease in toner specific charge. As a result, a fog-free good image can stably be formed on a non-image area over a long period of time.

The invention further provides an image forming apparatus comprising:

an image bearing member on which a latent image is to be formed;

a latent image forming section for forming a latent image on the image bearing member; and

the developing device mentioned above.

According to the invention, the image forming apparatus comprises the developing device of the invention. This constitution can establish both of good cleanability and fixability and can stably form a fog-free high quality image free of decrease in image quality due to decrease in toner specific charge, on a non-image area.

### BRIEF DESCRIPTION OF THE DRAWINGS

Other and further objects, features, and advantages of the invention will be more explicit from the following detailed description taken with reference to the drawings wherein:

FIG. 1 is a schematic view showing the constitution of an image forming apparatus in accordance with an embodiment of the invention; and

FIG. 2 is a schematic view showing a developing device mounted in the image forming apparatus shown in FIG. 1.

### DETAILED DESCRIPTION

Now referring to the drawings, preferred embodiments of the invention will be described in detail.

1. Toner

The toner according to one embodiment of the invention comprises toner particles, and silica particles and inorganic fine particles that are externally added to the toner particles, the inorganic fine particles having an average primary particle size smaller than that of the silica particles. The toner particles have a shape factor SF-1 of 130 or more and 140 or less and a shape factor SF-2 of 120 or more and 130 or less. The silica particles have an average primary particle size of 80 inn or more and 150 nm or less and an amount of water of 1.5% by weight or less.

(1) Toner Particles

The toner of the invention comprises the toner particles having a shape factor SF-1 of 130 or more and 140 or less and a shape factor SF-2 of 120 or more and 130 or less. The toner particles comprise a binder resin, a colorant, a release agent, a charge control agent and the like.

(Binder Resin)

The binder resin can use the conventional resins for use in toner, and examples thereof include polyester resins; styrenic resins such as polystyrene and styrene-acrylic acid ester copolymer resin; acrylic resins such as polymethyl methacrylate; polyolefinic resins such as polyethylene; polyurethane; and epoxy resins. Of those, polyester resins, acrylic resins and epoxy resins are preferred from the standpoints that those resins have excellent transparency, can impart good powder fluidity, low temperature fixability and secondary color reproducibility to the toner particles obtained, and are suitable for use in a binder resin of a color toner. Furthermore, grafted products of polyester resins and acrylic resins can preferably be used from the standpoint that low temperature fixability of a toner is achieved.

Considering that granulation operation is easily carried out and kneadability to a colorant and a shape and a size of particles obtained become uniform, a binder resin having a softening temperature of 150° C. or lower is preferred, and a binder resin having a softening point of from 60 to 150° C. is particularly preferred. Of those, a resin having a weight average molecular weight of from 50,000 to 300,000 is preferred. When the weight average molecular weight of the resin is less than 50,000, mechanical property after fixing is low, and phenomenon such as lack of image may occur. When the weight average molecular weight exceeds 300,000, low temperature fixability may be decreased.

The binder resins may be used each alone, or two or more thereof may be used in combination. Furthermore, even in the same resin, a plurality of resins in which either or the whole of molecular weight, monomer composition and the like differs can be used.

(Colorant)

Examples of the colorant include a dye and a pigment. Among them, a pigment is preferably used. The pigment has excellent light resistance and color formability as compared with a dye. Therefore, a toner having excellent light resistance and color formability can be obtained by using a pigment. Specific examples of the colorant include colorants for yellow toner, colorants for magenta toner, colorants for cyan toner and colorants for black toner.

Examples of a colorant for yellow include, for example, organic pigments such as C.I. pigment yellow 1, C.I. pigment yellow 5, C.I. pigment yellow 12, C.I. pigment yellow 15, C.I. pigment yellow 17, C.I. pigment yellow 74, C.I. pigment yellow 93, C.I. pigment yellow 180, and C.I. pigment yellow 185; inorganic pigments such as yellow iron oxide and yellow ocher; nitro dye such as C.I. acid yellow 1; and oil-soluble dye such as C.I. solvent yellow 2, C.I. solvent yellow 6, C.I. solvent yellow 14, C.I. solvent yellow 15, C.I. solvent yellow 19, and C.I. solvent yellow 21, which are all classified according to color index.

Examples of a colorant for magenta toner include, for example, C.I. pigment red 49, C.I. pigment red 57, C.I. pigment red 81, C.I. pigment red 122, C.I. solvent red 19, C.I. solvent red 49, C.I. solvent red 52, C.I. basic red 10, and C.I. disperse red 15, which are all classified according to color index.

Examples of a colorant for cyan toner include, for example, C.I. pigment blue 15, C.I. pigment blue 16, C.I. solvent blue 55, C.I. solvent blue 70, C.I. direct blue 25, and C.I. direct blue 86, which are all classified according to color index.

Examples of black toner colorant include, for example, carbon black such as channel black, roller black, disk black, gas furnace black, oil furnace black, thermal black, and acetylene black.

Other than these pigments, a bright red pigment, a green pigment, and the like may be used. The colorants may be used each alone, and two or more of may be used in combination. Further, two or more of the colorants of the same color series may be used together, and one or two or more colorants respectively selected from different color series may also be used together. The colorant is preferably used in form of a master batch. The master batch of the colorant can be manufactured, for example, by kneading a molten product of synthetic resin and the colorant. For the synthetic resin, a resin is used of the same sort as that of the binder resin of the toner, or used is a resin highly compatible with the binder resin of the toner. A usage ratio of the synthetic resin and the colorant is not particularly limited, and it is preferable that the colorant constitutes 30 parts by weight or more and 100 parts by weight or less based on 100 parts of the synthetic resin. The master batch is used, for example, with granulated particles around 2 mm or more and 3 mm or less in size.

The content of the colorant is not particularly limited, but is preferably from 4 to 20 parts by weight based on 100 parts by weight of the binder resin. This content can suppress a filler effect by the addition of a colorant and can obtain a toner having high coloring power. When the amount of the colorant compounded exceeds 20 parts by weight, fixability of the toner may be decreased by a filler effect of the colorant.

(Release Agent)

The release agent is added to impart releasability the toner in fixing the toner to a recording medium. Therefore, use of the release agent can increase high temperature offset initiation temperature as compared with the case that a release agent is not used, thereby improving high temperature offset resistance. Furthermore, the release agent can be melted by heat in fixing a toner, the fixation initiation temperature can be decreased, and hot offset resistance can be improved.

The release agent is not particularly limited, and heretofore known agent may be used including, for example: petroleum-based wax such as paraffin wax and derivatives thereof, and microcrystalline wax and derivatives thereof; hydrocarbon-based synthetic wax such as Fischer-Tropsch wax and derivatives thereof, polyolefin wax and derivatives thereof, low-molecular-weight polypropylene wax and derivatives thereof, and polyolefinic polymer wax and derivatives thereof; carnauba wax and derivatives thereof; and ester wax.

The amount of the release agent used in not particularly limited, and can appropriately be selected from a wide range. The amount is preferably from 0.2 to 20 parts by weight based on 100 parts by weight of the binder resin. When the release agent is contained in an amount larger than 20 parts by weight, filming on a photoreceptor and spent on a carrier may easily occur. When the release agent is used in an amount less than 0.2 part by weight, the function of the release agent may not sufficiently be exhibited. A melting point of the release agent is not particularly limited. However, when the melting point is too high, the effect is not obtained in the improvement of fixability (releasability), and too low melting point deteriorates storage stability. Therefore, the melting point is preferably from 30 to 120° C.

(Charge Control Agent)

The addition of the charge control agent gives the toner a favorable charging property. The usable charge control agent in the invention includes a positive charge control agent and a negative charge control agent. The positive charge control agent includes, for example, a basic dye, quaternary ammonium salt, quaternary phosphonium salt, aminopyrine, a pyrimidine compound, a polynuclear polyamino compound, aminosilane, a nigrosine dye, a derivative thereof, a triphenylmethane derivative, guanidine salt, and amidine salt.

The negative charge control agent includes oil-soluble dyes such as oil black and spiron black, a metal-containing azo compound, an azo complex dye, metal salt naphthenate, salicylic acid, metal complex and metal salt (the metal includes chrome, zinc, and zirconium) of a salicylic acid derivative, a boron compound, a fatty acid soap, long-chain alkylcarboxylic acid salt, and a resin acid soap.

The charge control agents may be used each alone, or two or more thereof may be used in combination. A usage of the compatible charge control agent is preferably 0.5 part by weight or more and 5 parts by weight or less based on 100 parts by weight of the binder resin, and more preferably 0.5 part by weight or more and 3 parts by weight or less based on 100 parts by weight of the binder resin. When the content of the charge control agent is larger than 5 parts by weight, a carrier is contaminated, causing the toner to spatter. When the content of the non-compatible charge control agent is less than 0.5 part by weight, the toner is not given a sufficient charging property.

(Production Method for Toner Particles)

Although the toner particles can be obtained by a known production method without any particular limitation, the toner particles can be produced by, for example, a melt-kneading pulverization method. According to the melt-kneading pulverization method, a binder resin, a coloring agent, a release agent, a charge control agent and any other additives are dry-mixed together in predetermined amounts, the obtained mixture is melt-kneaded, the obtained melt-kneaded product is cooled and solidified, and the obtained solidified product is mechanically pulverized.

As a mixer used for dry-mixing, there can be used a Henschel type mixer, such as HENSCHELMIXER (trade name, manufactured by Mitsui Mining Co., Ltd.), SUPERMIXER (trade name, manufactured by Kawata MFG Co., Ltd.) and MECHANOMIL (trade name, manufactured by Okada Seiko Co., Ltd.); ANGMIL (trade name, manufactured by Hosokawa Micron Corporation), HYBRIDIZATION SYSTEM (trade name, manufactured by Nara Machinery Co., Ltd.), and COSMOSYSTEM (trade name, manufactured by Kawasaki Heavy Industries, Ltd.)

The kneading is effected with stirring while being heated at a temperature (usually, about 80 to about 200°, preferably, about 100 to about 150° C.) higher than the melting temperature of the binder resin.

As a kneader, a generally employed kneader can be used, such as a biaxial extruder, a three-roll mill or a laboplast mill. More concretely, there can be used a monoaxial or biaxial extruder such as TEM-100B (trade name, manufactured by Toshiba Machine Co., Ltd.) or PCM-65/87 (trade name, manufactured by Ikegai, Ltd.), or the one of the open roll system such as Kneadex (trade name, manufactured by Mitsui Mining Co., Ltd.) Among them, the one of the open roll system is preferred.

The solidified product obtained by cooling the melt-kneaded product is pulverized by using a cutter mill, a Feather mill or a jet mill. For example, the solidified product is coarsely pulverized by using the cutter mill and is, next, pulverized by the jet mill to obtain a toner particle having a desired volume average particle size.

The toner particles can be further produced by, for example, coarsely pulverizing the solidified product the melt-kneaded product, forming an aqueous slurry of the obtained coarsely pulverized product, atomizing the obtained aqueous slurry by using a high-pressure homogenizer, and heating, aggregating and melting the obtained fine particles in an aqueous medium.

The solidified product of the melt-kneaded product is coarsely pulverized by using, for example, the jet mill or the hand mill. Through the rough pulverization, coarse particles having a particle size of about 100 μm to about 500 μm is obtained. The coarse particles are dispersed in water to prepare an aqueous slurry thereof. To disperse the coarse particles in water, a dispersant such as sodium dodecylbenzenesulfonate or the like is dissolved in a suitable amount in water to obtain an aqueous slurry in which the coarse particles are homogeneously dispersed. Upon treating the aqueous slurry by using a high-pressure homogenizer, the coarse particles in the aqueous slurry are atomized; i.e., an aqueous slurry is obtained containing fine particles having a volume average particle size of about 0.4 to about 1.0 μm. The aqueous slurry is heated to aggregate fine particles which are, then, melt-bonded together to obtain a toner particle having a desired volume average particle size and an average circularity degree.

The volume average particle size and the average circularity degree can be adjusted to desired values by, for example, suitably selecting the temperature for heating the aqueous slurry of fine particles and the time for heating. The heating temperature is suitably selected from a temperature range which is not lower than the softening temperature of the binder resin but is lower than the thermal decomposition temperature of the binder resin. If the time for heating is the same, the volume average particle size of the toner particle, usually, increases with an increase in the heating temperature.

As a high-pressure homogenizer, there have been known those placed in the market. As a high-pressure homogenizer placed in the market, there can be exemplified chamber-type high-pressure homogenizers such as MICROFLUIDIZER (trade name, manufactured by Microfluidics Corporation), NANOMIZER (trade name, manufactured by Nanomizer Inc.) and ALTIMIZER (trade name, manufactured by Sugino Machine Ltd.), as well as HIGH-PRESSURE HOMOGENIZER (trade name, manufactured by Rannie Inc.), HIGH-PRESSURE HOMOGENIZER (trade name, manufactured by Sanmaru Machinery Co., Ltd.), HIGH-PRESSURE HOMOGENIZER (trade name, manufactured by Izumi Food Machinery Co., Ltd.) and NANO3000 (trade name, manufactured by Beryu Co., Ltd.)

A volume average particle size of the toner particles thus obtained is from 5 μm to 8 μm. When the volume average particle size of the toner particles is less than 5 μm, the particle size is too small, and even though silica particles having a large particle size in which an average primary particle size is from 80 nm to 150 nm are externally added, cleaning performance cannot be secured. When the volume average particle size of the toner particles exceeds 8 μm, the particle size is too large, and even though silica particles having a large particle size in which an average primary particle size is from 80 nm to 150 nm are externally added, further effect of improving cleaning performance is not obtained. Furthermore, image quality is decreased. When the volume average particle size of the toner particles falls within a range of 80 nm or more and 150 nm or less, an image having high image quality can be formed and cleaning performance can be secured.

Spheronization treatment may be applied to the toner particles. A device for the spheronization includes an impact-type spheronization apparatus and a hot air-type spheronization apparatus. The impact-type spheronization apparatus can use the commercially available apparatuses. For example, FACULTY (trade name, manufactured by Hosokawa Micron Corporation) and HYBRIDIZATION SYSTEM (trade name, manufactured by Nara Machinery Co., Ltd.) can be used. The hot air-type spheronization apparatus can use the commercially available apparatuses. For example, a surface fusing system, METEORIANBOW (trade name, manufactured by Nippon Pneumatic Mfg. Co., Ltd.) can be used.

(2) External Additives

### (Silica Particles)

The toner particles thus prepared are mixed with the silica particles having an average primary particle size of 80 nm or more and 150 nm or less and an amount of water of 1.5% by weight or less. The silica particles have the functions to improve powder fluidity, to improve frictional chargeability, to improve heat resistance, to improve long-term storage stability, to improve cleaning characteristics and to control surface abrasion characteristics of a photoreceptor. The amount of water in the silica particles is measured with Karl Fisher 105° C. heating loss method.

The mixing method is conducted by optional method. For example, the mixing can be carried out with V-blender, Henschel mixer, ribbon blender or automatic mortar. The silica particles are externally added to the toner particles by mixing the toner particles and the silica particles in those apparatuses.

When a particle size distribution of the silica particles is a logarithmic normal distribution, the value of geometric standard deviation σ_{g} of a particle size of the silica particles is less than 1.30. The geometric standard deviation (σ_{g}) of a particle size of the silica particles is obtained by dividing an average particle size of the silica particles by 15.87% particle size integrally sieved, or dividing 84.13% particle size integrally sieved by an average particle size of the silica particles, and is widely used as a measure to show a degree of homogeneity of a particle size distribution. The value obtained by dividing an average particle size of silica particles by 15.87% particle size and the value obtained by dividing 84.13% particle size by an average particle size of the silica particles are exactly the same value. When the value of geometric standard deviation σ_{g} of a particle size of the silica particles is less than 1.30, the number between silica particles having a large particle size and silica particles having a small particle size in a particle size distribution of the silica particles can appropriately be adjusted, and as a result, decrease in toner specific charge by contact failure between a toner and a carrier can be suppressed. Furthermore, decrease in fixability due to silica particles of 30 nm or less can be suppressed. Therefore, cleaning performance to a photoreceptor drum and a transfer belt can stably be secured and decrease in toner specific charge in a print duration test can further be suppressed.

The silica particles are preferably subjected to hydrophobization treatment. The hydrophobicization treatment can decrease change in toner specific charge between high temperature and high humidity environment and low temperature and low humidity environment. Therefore, cleaning performance to a photoreceptor drum and a transfer belt can stably be secured and decrease in toner specific charge in a print duration test can be suppressed, regardless of humidity.

A method for hydrophobizing the silica particles is not particularly limited, and can use the conventional methods. One example of the method includes a method for hydrophobizing the silica particles using a hydrophobizing agent such as a silane coupling agent, a silylating agent, a silane coupling agent having an alkyl fluoride group, an organotitanate type coupling agent, an aluminum type coupling agent, a silicon oil or a silicon varnish.

The silica particles preferably have a specific surface area of 30 m²/g or more and 55 m²/g or less. When the specific surface area is less than 30 m²/g, the number of the silica particles having a large particle size is increased, and contact failure between a toner and a carrier is generated, resulting in decrease in toner specific charge. When the specific surface area exceeds 55 m²/g, the number of the silica particles having a small particle size is increased, resulting in decrease in toner fixability. When the specific surface area of the silica particles falls within a range of 30 m²/g or more and 55 m²/g or less, decrease in toner specific charge in a print duration test can further be suppressed. Furthermore, the number of the silica particle having a small particle size can be reduced, thereby fixability can be secured.

The specific surface area of the silica particles is measured with BET three-point method in which gradient A is obtained from a nitrogen absorption amount to three points of relative pressure and a value of specific surface area is obtained from BET equation.

The silica particles are preferably externally added in a proportion of 0.5 part by weight or more and 3.0 parts by weight or less based on 100 parts by weight of the toner particles. When the proportion of the silica particles externally added is less than 0.5 part by weight based on 100 parts by weight of the toner particles, cleaning performance of a toner cannot be secured. When the proportion of the silica particles externally added exceeds 3.0 parts by weight based on 100 parts by weight of the toner particles, the silica particles easily drop off from the toner particles. Therefore, decrease in toner specific discharge in a print duration test is generated, resulting in decrease in image quality of a printed image and scatter of a toner in the apparatus. When the silica particles are externally added in a proportion of 0.5 part by weight or more and 3.0 parts by weight or less based on 100 parts by weight of the toner particles, cleaning performance of a toner can be secured, and decrease in toner specific charge in a print duration test can further be suppressed.

(Inorganic Fine Particles)

In the present embodiment, the inorganic fine particles having an average primary particle size smaller than that of the silica particles are externally added to the toner particles together with the silica particles having an average primary particle size of 80 nm or more and 150 nm or less. The average primary particle size of the inorganic fine particles is preferably from 7 nm to 20 nm.

Examples of the inorganic fine particles having an average primary particle size smaller than that of the silica particles include a fine powder of silica particles, a titanium oxide fine powder and an alumina fine powder.

The inorganic fine particles may be used each alone, or two or more thereof may be used in combination. An amount of the inorganic fine particles to be added is preferably 2 parts by weight or less based on 100 parts by weight of the toner particle, in view of charge quantity required for the toner, influence on photoreceptor wear through addition of the external additive, environmental characteristics of the toner, and the like.

A particle size of the silica particles and the inorganic fine particles having an average primary particle size smaller than that of the silica particles, used in the invention can be measured with a particle size analyzer utilizing dynamic light scattering, such as DLS-800, manufactured by Otsuka Electronics Co., Ltd., and COULTER N4, manufactured by Coulter Electronics. However, it is difficult to isolate secondary aggregates of particles after hydrophobization treatment. Therefore, the particle size is preferably obtained directly from photographs obtained by a scanning electron microscope (SEM) or a transmission electron microscope (TEM).

As described before, the toner of the present embodiment comprises the toner particles, and the silica particles and the inorganic fine particles are externally added to the toner particles, the inorganic fine particles having an average primary particle size smaller than that of the silica particles. The toner particles have a shape factor SF-1 of 130 or more and 140 or less and a shape factor SF-2 of 120 or more and 130 or less, and the silica particles have an average primary particle size of 80 nm or more and 150 nm or less, and the amount of water of 1.5% by weight or less.

When the shape factor SF-1 of the toner particles is less than 130, the toner particle shape is close to a perfect spherical shape. Therefore, even though silica particles having a large particle size in which an average primary particle size is from 80 nm to 150 nm are externally added, cleaning performance cannot be improved. When the shape factor SF-1 of the toner particles exceeds 140, because the toner particles originally have irregular shapes, even though silica particles having a large particle size in which an average primary particle size is from 80 nm to 150 nm are externally added, further improvement effect of the cleaning performance is not obtained. Furthermore, the transfer efficiency is decreased.

When the shape factor SF-2 of the toner particles is less than 120, irregularities on the surface of toner particles are too few. Therefore, adhesion of silica particles having a large particle size in which an average primary particle size is from 80 nm to 150 nm to the toner particles is decreased, and cleaning performance cannot be improved. When the shape factor SF-2 of the toner particles exceeds 130, the silica particles having a large particle size in which an average primary particle size is from 80 nm to 150 nm enter the depressed portions, and spacer effect of the silica particles having a large particle size is not exhibited, resulting in decrease in transfer efficiency.

When the average primary particle size of the silica particles is less than 80 nm, cleaning performance is not obtained. Additionally, the number of silica particles having a small particle size of 30 nm or less is increased, the surface of the toner particles is covered with the particles more than necessary, and the effect of oozing a release agent contained in the toner particles is inhibited, resulting in deterioration of fixability. When the average primary particle size of the silica particles exceeds 150 nm, contact failure between the toner and the carrier is generated, resulting in decrease in toner specific charge.

When the amount of water in the silica particles exceeds 1.5% by weight, electric charges charged on the surface of a toner leak through the silica particles, resulting in decrease in toner specific charge.

When the silica particles having an average primary particle size of 80 nm or more and 150 nm or less and the amount of water of 1.5% by weight or less are externally added to the toner particles having the shape factor SF-1 of 130 or more and 140 or less and the shape factor SF-2 of 120 or more and 130 or less, cleaning performance to a photoreceptor drum and a transfer belt can be secured, and decrease in toner specific charge in a print duration test can be suppressed. Formation of an image using such a toner can suppress decrease in image quality of a printed image and can reduce scatter of toner in an apparatus.

Furthermore, when the silica particles having an average primary particle size of 80 nm or more and 150 nm or less and inorganic fine particles having an average primary particle size smaller than that of the silica particles are externally added in combination, mixability between the toner particles and the silica particles is improved in the external addition treatment, and the silica particles can uniformly be dispersed on the surface of the toner particles. As a result, fluidity of the toner can be secured and rising of toner charging can be fastened.

3. Developer

The toner of the invention manufactured as above can be used as one-component developer without change and can also be mixed with a carrier to be used in form of a two-component developer.

Thus, when the developer comprises the toner of the invention, a developer that can achieve both of good cleanability and fixability and can suppress decrease in toner specific charge in the print duration test can be obtained.

Furthermore, when the developer is a two-component developer comprising the toner of the invention and a carrier, a developer that can achieve both of good cleanability and fixability and can suppress decrease in toner specific charge in a print duration test can be obtained, thereby an image having high image quality can be formed.

[Carrier]

As a carrier, magnetic particles can be used. Specific examples of the magnetic particles include metals such as iron, ferrite, and magnetite; and alloys composed of the metals just cited and metals such as aluminum or lead. Among these examples, ferrite is preferred.

Further, the carrier can be a resin-coated carrier in which the magnetic particles are coated with resin, or a dispersed-in-resin carrier in which the magnetic particles are dispersed in resin. The resin used for coating the magnetic particles includes, but is not particularly limited to, for example, an olefin-based resin, a styrene-based resin, a styrene-acrylic resin, a silicone-based resin, an ester-based resin, and a fluorine-containing polymer-based resin. The resin used for the dispersed-in-resin carrier includes, but is not particularly limited either to, for example, a styrene-acrylic resin, a polyester resin, a fluorine-based resin, and a phenol resin.

A shape of the carrier is preferably spherical or flat. Further, the particle size of the carrier is not particularly limited, but in consideration of enhancement in image quality, it is preferably 30 μm or more and 50 μm or less. Furthermore, resistivity of the carrier is preferably 10⁸ Ω·cm or more and more preferably 10¹² Ω·cm or more. The carrier's resistivity is obtained as follows. The carrier is put in a vessel having a cross-sectional area of 0.50 cm² and crammed in the vessel by tapping and then, a load of 1 kg/cm² is imposed on the carrier in the vessel while a voltage is applied between the load and a bottom electrode to generate an electric field of 1,000 V/cm there. In the situation just described, a current value is read from which the carrier's resistivity is derived. The low resistivity will cause charge injection into a carrier when a bias voltage is applied to the developing sleeve, and this makes the carrier particles become more likely to adhere to a photoreceptor. In addition, this induces breakdown of the bias voltage more frequently.

Magnetization intensity (maximum magnetization) of the carrier is preferably 10 emu/g to 60 emu/g, and more preferably 15 emu/g to 40 emu/g. The magnetization intensity depends on magnetic flux density of the developing roller. Under a condition that the developing roller has normal magnetic flux density, the magnetization intensity less than 10 emu/g will lead to a failure to exercise magnetic binding force, which may cause the carrier to spatter. When the magnetization intensity exceeds 60 emu/g, it becomes difficult to keep a noncontact state with an image bearing member in a noncontact development where brush of the carrier is too high, and in a contact development, sweeping patterns may appear more frequently in a toner image.

A use ratio between the toner and the carrier contained in the two-component developer is not particularly limited and may be appropriately selected according to kinds of the toner and the carrier. To take the case of the resin-coated carrier (having density of 5 g/cm² to 8 g/cm²) as an example, it is preferable to use the toner in such an amount that the content of the toner in the developer is 2% by weight or more and 30% by weight or less, more preferably 2% by weight or more and 20% by weight or less, of a total amount of the developer. Further, in the two-component developer, the coverage of the toner over the carrier is preferably 40% or more and 80% or less.

3. Image Forming Apparatus

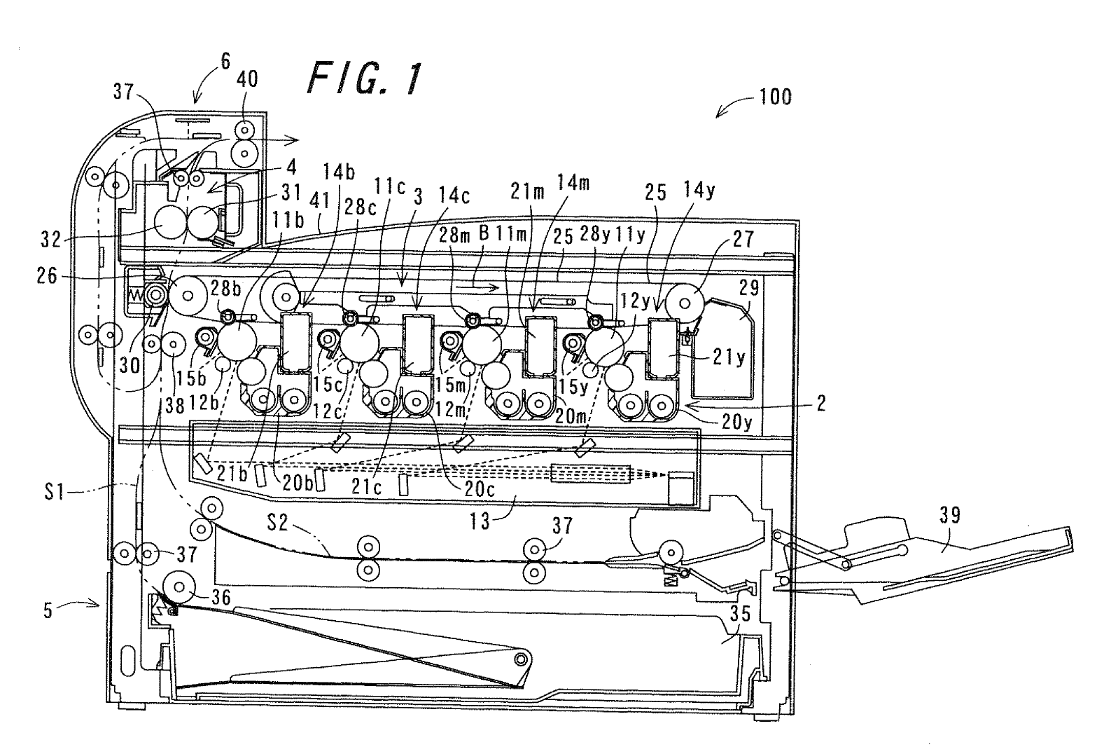

FIG. 1 is a schematic view showing a configuration of an image forming apparatus 100 according to another embodiment of the invention. The image forming apparatus 100 is a multifunctional peripheral having a copier function, a printer function, and a facsimile function together, and according to image information being conveyed to the image farming apparatus 100, a full-color or monochrome image is formed on a recording medium. That is, the image forming apparatus 100 has three types of print mode, i.e., a copier mode, a printer mode and a FAX mode, and the print mode is selected by a control unit (not shown) in accordance with, for example, the operation input from an operation portion (not shown) and reception of the printing job from external equipment such as a personal computer, a mobile device, an information recording storage medium, and a memory device.

The image forming apparatus 100 includes a photoreceptor drum 11 serving as an image bearing member, an image forming section 2, a transfer section 3, a fixing section 4, a recording medium feeding section 5, and a discharging section 6. In accordance with image information of respective colors of black (b), cyan (c), magenta (m), and yellow (y) which are contained in color image information, there are provided respectively four sets of the components constituting the image forming section 2 and some parts of the components contained in the transfer section 3. The four sets of respective components provided for the respective colors are distinguished herein by giving alphabets indicating the respective colors to the end of the reference numerals, and in the case where the sets are collectively referred to, only the reference numerals are shown.

The image forming section 2 includes a charging section 12, an exposure unit 13, a developing device 14, and a cleaning unit 15. The charging section 12 and the exposure unit 13 function as a latent image forming section. The charging section 12, the developing device 14, and the cleaning unit 15 are disposed around the photoreceptor drum 11 in the order just stated. The charging section 12 is disposed vertically below the developing device 14 and the cleaning unit 15.

The photoreceptor drum 11 is a roller-shaped member which is rotatably disposed about an axis thereof by a rotation-driving section (not shown) and on which surface part an electrostatic latent image is formed. The rotation-driving section of the photoreceptor drum 11 is controlled by a control unit implemented by a central processing unit (CPU). The photoreceptor drum 11 includes a conductive substrate (not shown) and a photosensitive layer (not shown) formed on a surface of the conductive substrate. The conductive substrate may be formed into various shapes such as a cylindrical shape, a circular columnar shape, and a thin film sheet shape. Among these shapes, the cylindrical shape is preferred. The conductive substrate is formed of a conductive material.

As the conductive material, those customarily used in the relevant field can be used including, for example, metals such as aluminum, copper, brass, zinc, nickel, stainless steel, chromium, molybdenum, vanadium, indium, titanium, gold, and platinum; alloys formed of two or more of the metals; a conductive film in which a conductive layer containing one or two or more of aluminum, aluminum alloy, tin oxide, gold, indium oxide, etc. is formed on a film-like substrate such as a synthetic resin film, a metal film, and paper; and a resin composition containing at least conductive particles and/or conductive polymers. As the film-like substrate used for the conductive film, a synthetic resin film is preferred and a polyester film is particularly preferred. Further, as the method of forming the conductive layer in the conductive film, vapor deposition, coating, and the like, are preferred.

The photosensitive layer is formed, for example, stacking a charge generating layer containing a charge generating substance, and a charge transporting layer containing a charge transporting substance. In this case, an undercoat layer is preferably formed between the conductive substrate and the charge generating layer or the charge transporting layer. When the undercoat layer is provided, the flaws and irregularities present on the surface of the conductive substrate are covered, leading to advantages such that the photosensitive layer has a smooth surface, that chargeability of the photosensitive layer can be prevented from degrading during repetitive use, and that the charging property of the photosensitive layer can be enhanced under a low temperature circumstance and/or a low humidity circumstance. Further, the photosensitive layer may be a laminated photoreceptor having a highly-durable three-layer structure in which a photoreceptor surface-protecting layer is provided on the top layer.

The charge generating layer contains as a main ingredient a charge generating substance that generates charge under irradiation of light, and optionally contains known binder resin, plasticizer, sensitizer, etc. As the charge generating substance, materials used customarily in the relevant field can be used including, for example, perylene pigments such as perylene imide and perylenic acid anhydride; polycyclic quinone pigments such as quinacridone and anthraquinone; phthalocyanine pigments such as metal and non-metal phthalocyanines, and halogenated non-metal phthalocyanines; squalium dyes; azulenium dyes; thiapylirium dyes; and azo pigments having carbazole skeleton, styrylstilbene skeleton, triphenylamine skeleton, dibenzothiophene skeleton, oxadiazole skeleton, fluorenone skeleton, bis-stilbene skeleton, di-styryloxadiazole skeleton, or di-styryl carbazole skeleton. Among those charge generating substances, non-metal phthalocyanine pigments, oxotitanyl phthalocyanine pigments, bisazo pigments containing fluorene rings and/or fluorenone rings, bisazo pigments containing aromatic amines, and trisazo pigments have high charge generating ability and are suitable for forming a highly-sensitive photosensitive layer. The charge generating substances may be used each alone, or two or more thereof may be used in combination. The content of the charge generating substance is not particularly limited, and preferably 5 parts by weight or more and 500 parts by weight or less, more preferably 10 parts by weight or more and 200 parts by weight or less based on 100 parts by weight of the binder resin in the charge generating layer. Also as the binder resin for charge generating layer, materials used customarily in the relevant field can be used including, for example, melamine resin, epoxy resin, silicone resin, polyurethane, acrylic resin, vinyl chloride-vinyl acetate copolymer resin, polycarbonate, phenoxy resin, polyvinyl butyral, polyallylate, polyamide, and polyester. The binder resins may be used each alone or, as required, two or more thereof may be used in combination.

The charge generating layer can be formed by dissolving or dispersing an appropriate amount of a charge generating substance, a binder resin and, optionally, a plasticizer, a sensitizer, etc. respectively in an appropriate organic solvent in which the ingredients described above are dissolvable or dispersible, to thereby prepare a coating solution for charge generating layer, and then applying the coating solution for charge generating layer to the surface of the conductive substrate, followed by drying the coated surface. The thickness of the charge generating layer obtained in this way is not particularly limited, and preferably is 0.05 μm or more and 5 μm or less, more preferably 0.1 μm or more and 2.5 μm or less.

The charge transporting layer stacked over the charge generating layer contains as essential ingredients a charge transporting substance having an ability of receiving and transporting the charge generated from the charge generating substance, and a binder resin for charge transporting layer, and optionally contains known antioxidant, plasticizer, sensitizer, lubricant, etc. As the charge transporting substance, materials used customarily in the relevant field can be used including, for example: electron donating materials such as poly-N-vinyl carbazole, a derivative thereof, poly-γ-carbazolyl ethyl glutamate, a derivative thereof, a pyrene-formaldehyde condensation product, a derivative thereof, polyvinylpyrene, polyvinyl phenanthrene, an oxazole derivative, an oxadiazole derivative, an imidazole derivative, 9-(p-diethylaminostyryl)anthracene, 1,1-bis(4-dibenzylaminophenyl)propane, styrylanthracene, styrylpyrazoline, a pyrazoline derivative, phenyl hydrazones, a hydrazone derivative, a triphenylamine compound, a tetraphenyldiamine compound, a triphenylmethane compound, a stilbene compound, and an azine compound having 3-methyl-2-benzothiazoline ring; and electron accepting materials such as a fluorenone derivative, a dibenzothiophene derivative, an indenothiophene derivative, a phenanthrenequinone derivative, an indenopyridine derivative, a thioquisantone derivative, a benzo[c]cinnoline derivative, a phenazine oxide derivative, tetracyanoethylene, tetracyanoquinodimethane, bromanil, chloranil, and benzoquinone. The charge transporting substances may be used each alone, or two or more thereof may be used in combination. The content of the charge transporting substance is not particularly limited, and preferably is 10 parts by weight or more and 300 parts by weight or less, more preferably 30 parts by weight or more and 150 parts by weight or less, based on 100 parts by weight of the binder resin in the charge transporting substance.

As the binder resin for charge transporting layer, it is possible to use materials which are used customarily in the relevant field and capable of uniformly dispersing the charge transporting substance, including, for example, polycarbonate, polyallylate, polyvinylbutyral, polyamide, polyester, polyketone, an epoxy resin, polyurethane, polyvinylketone, polystyrene, polyacrylamide, a phenolic resin, a phenoxy resin, a polysulfone resin, and a copolymer resin thereof. Among those materials, in view of the film forming property, and the wear resistance, an electrical property etc. of the obtained charge transporting layer, it is preferable to use, for example, polycarbonate which contains bisphenol Z as the monomer ingredient (hereinafter referred to as “bisphenol Z polycarbonate”), and a mixture of bisphenol Z polycarbonate and other polycarbonate. The binder resins may be used each alone, or two or more thereof may be used in combination.

The charge transporting layer preferably contains an antioxidant in addition to the charge transporting substance and the binder resin for charge transporting layer. Also for the antioxidant, materials used customarily in the relevant field can be used including, for example, Vitamin E, hydroquinone, hindered amine, hindered phenol, paraphenylene diamine, arylalkane, and derivatives thereof, an organic sulfur compound, and an organic phosphorus compound. The antioxidants may be used each alone, or two or more thereof may be used in combination. The content of the antioxidant is not particularly limited, and is 0.01% by weight or more and 10% by weight or less, preferably 0.05% by weight or more and 5% by weight or less, of the total amount of the ingredients constituting the charge transporting layer.

The charge transporting layer can be formed by dissolving or dispersing an appropriate amount of a charge transporting substance, a binder resin and, optionally, an antioxidant, a plasticizer, a sensitizer, etc. respectively in an appropriate organic solvent which is capable of dissolving or dispersing the ingredients described above, to thereby prepare a coating solution for charge transporting layer, and applying the coating solution for charge transporting layer to the surface of a charge generating layer, followed by drying the coated surface. The thickness of the charge transporting layer obtained in this way is not particularly limited, and preferably is 10 μm or more and 50 μm or less, more preferably 15 μm or more and 40 μm or less.

It is also possible to form a photosensitive layer in which a charge generating substance and a charge transporting substance are present in one layer. In this case, the kinds and contents of the charge generating substance and the charge transporting substance, the kind of the binder resin, and other additives may be the same as those in the case of forming separately the charge generating layer and the charge transporting layer.

In the embodiment, there is used a photoreceptor drum which has an organic photosensitive layer as described above containing the charge generating substance and the charge transporting substance. It is, however, also possible to use, instead of the above photoreceptor drum, a photoreceptor drum which has an inorganic photosensitive layer containing silicon or the like.

The charging section 12 faces the photoreceptor drum 11 and is disposed away from the surface of the photoreceptor drum 11 when viewed in a longitudinal direction of the photoreceptor drum 11. The charging section 12 charges the surface of the photoreceptor drum 11 so that the surface of the photoreceptor drum 11 has predetermined polarity and potential. As the charging section 12, it is possible to use a charging brush type charging device, a charger type charging device, a pin array type charging device, an ion-generating device, etc. Although the charging section 12 is disposed away from the surface of the photoreceptor drum 11 in the embodiment, the configuration is not limited thereto. For example, a charging roller may be used as the charging section 12, and the charging roller may be disposed in pressure-contact with the photoreceptor drum 12. It is also possible to use a contact-charging type charger such as a charging brush or a magnetic brush.

The exposure unit 13 is disposed so that light beams corresponding to each color information emitted from the exposure unit 13 pass between the charging section 12 and the developing device 14 and reach the surface of the photoreceptor drum 11, In the exposure unit 13, the image information is converted into light beams corresponding to each color information of black, cyan, magenta, and yellow, and the surface of the photoreceptor drum 11 which has been evenly charged by the charging section 12, is exposed to the light beams corresponding to each color information to thereby form electrostatic latent images on the surfaces of the photoreceptor drums 11. As the exposure unit 13, it is possible to use a laser scanning unit having a laser-emitting portion and a plurality of reflecting mirrors. The other usable examples of the exposure unit 13 may include an LED array and a unit in which a liquid-crystal shutter and a light source are appropriately combined with each other.

The cleaning unit 15 removes the toner which remains on the surface of the photoreceptor drum 11 after the toner image formed on the surface of the photoreceptor drum 11 by the developing device 14 has been transferred to the recording medium, and thus cleans the surface of the photoreceptor drum 11. In the cleaning unit 15, a platy member is used such as a cleaning blade. In the image forming apparatus of the invention, an organic photoreceptor drum is mainly used as the photoreceptor drum 11. A surface of the organic photoreceptor drum contains a resin component as a main ingredient and therefore tends to be degraded by chemical action of ozone which is generated by corona discharging of a charging device. The degraded surface part is, however, worn away by abrasion through the cleaning unit 15 and thus removed reliably, though gradually. Accordingly, the problem of the surface degradation caused by the ozone, etc. is actually solved, and the potential of charge given in the charging operation can be thus maintained stably for a long period of time. Although the cleaning unit 15 is provided in the embodiment, no limitation is imposed on the configuration and the cleaning unit 15 does not have to be provided.

In the image forming section 2, signal light corresponding to the image information is emitted from the exposure unit 13 to the surface of the photoreceptor drum 11 which has been evenly charged by the charging section 12, thereby forming an electrostatic latent image; the toner is then supplied from the developing device 14 to the electrostatic latent image, thereby forming a toner image; the toner image is transferred to an intermediate transfer belt 25; and the toner which remains on the surface of the photoreceptor drum 11 is removed by the cleaning unit 15. A series of the toner image forming operations just described is repeatedly carried out.

The transfer section 3 is disposed above the photoreceptor drum 11 and includes the intermediate transfer belt 25, a driving roller 26, a driven roller 27, four intermediate transfer rollers 28 which respectively correspond to image information of the colors, i.e. black, cyan, magenta, and yellow, a transfer belt cleaning unit 29, and a transfer roller 30. The intermediate transfer belt 25 is an endless belt supported around the driving roller 26 and the driven roller 27 with tension, thereby forming a loop-shaped travel path. The intermediate transfer belt 25 rotates in an arrow B direction. The driving roller 26 can rotate around an axis thereof with the aid of a driving section (not shown), and the rotation of the driving roller 26 drives the intermediate transfer belt 25 to rotate in the arrow B direction. The driven roller 27 can rotate depending on the rotational drive of the driving roller 26, and imparts constant tension to the intermediate transfer belt 25 so that the intermediate transfer belt 25 does not go slack. The intermediate transfer roller 28 is disposed in pressure-contact with the photoreceptor drum 11 with the intermediate transfer belt 25 interposed therebetween, and capable of rotating around its own axis by a driving section (not shown). The intermediate transfer roller 28 is connected to a power source (not shown) for applying the transfer bias voltage as described above, and has a function of transferring the toner image formed on the surface of the photoreceptor drum 11 to the intermediate transfer belt 25.

When the intermediate transfer belt 25 passes by the photoreceptor drum 11 in contact therewith, the transfer bias voltage whose polarity is opposite to the polarity of the charged toner on the surface of the photoreceptor drum 11 is applied from the intermediate transfer roller 28 which is disposed opposite to the photoreceptor drum 11 with the intermediate transfer belt 25 interposed therebetween, with the result that the toner image formed on the surface of the photoreceptor drum 11 is transferred onto the intermediate transfer belt 25. In the case of a multicolor image, the toner images of respective colors formed on the respective photoreceptor drums 11 are sequentially transferred and overlaid onto the intermediate transfer belt 25, thus forming a full-color toner image.

The transfer belt cleaning unit 29 is disposed opposite to the driven roller 27 with the intermediate transfer belt 25 interposed therebetween so as to come into contact with an outer circumferential surface of the intermediate transfer belt 25. The residual toner which is attached to the intermediate transfer belt 25 as it comes into contact with the photoreceptor drum 11, may cause contamination on a reverse side of the recording medium. The transfer belt cleaning unit 29 therefore removes and collects the toner on the surface of the intermediate transfer belt 25.

The transfer roller 30 is disposed in pressure-contact with the driving roller 26 with the intermediate transfer belt 25 interposed therebetween, and capable of rotating around its own axis by a driving section (not shown). In a pressure-contact region, i.e., a transfer nip region, between the transfer roller 30 and the driving roller 26, a toner image which has been borne on the intermediate transfer belt 25 and thereby conveyed to the pressure-contact region is transferred onto a recording medium fed from the later-described recording medium feeding section 5. The recording medium bearing the toner image is fed to the fixing section 4.

In the transfer section 3, the toner image is transferred from the photoreceptor drum 11 onto the intermediate transfer belt 25 in the pressure-contact region between the photoreceptor drum 11 and the intermediate transfer roller 28, and by the intermediate transfer belt 25 rotating in the arrow B direction, the transferred toner image is conveyed to the transfer nip region where the toner image is transferred onto the recording medium.

The fixing section 4 is provided downstream of the transfer section 3 along a conveyance direction of the recording medium, and contains a fixing roller 31 and a pressure roller 32. The fixing roller 31 can rotate by a driving section (not shown), and heats the toner constituting an unfixed toner image borne on the recording medium so that the toner is fused. Inside the fixing roller 31 is provided a heating portion (not shown). The heating portion heats the heating roller 31 so that a surface of the heating roller 31 has a predetermined temperature (which may also be hereinafter referred to as “heating temperature”). For the heating portion, a heater, a halogen lamp, and the like device can be used, for example. The heating portion is controlled by a fixing condition controlling portion.

In the vicinity of the surface of the fixing roller 31 is provided a temperature detecting sensor (not shown) which detects a surface temperature of the fixing roller 31. A result detected by the temperature detecting sensor is written to a memory portion of the later-described control unit. The pressure roller 32 is disposed in pressure-contact with the fixing roller 31, and supported so as to be rotate by the rotational drive of the fixing roller 31. The pressure roller 32 fixes the toner image onto the recording medium in cooperation with the fixing roller 31. At this time, the pressure roller 32 assists in the fixation of the toner image onto the recording medium by pressing the toner in fused state due to the heat of the fixing roller 31 against the recording medium. A pressure-contact region between the fixing roller 31 and the pressure roller 32 is a fixing nip region.

In the fixing section 4, the recording medium onto which the toner image has been transferred in the transfer section 3 is nipped by the fixing roller 31 and the pressure roller 32 so that when the recording medium passes through the fixing nip region, the toner image is pressed and thereby fixed onto the recording medium under heat, whereby an image is formed.

The recording medium feeding section 5 includes an automatic paper feed tray 35, a pickup roller 36, conveying rollers 37, registration rollers 38, and a manual paper feed tray 39. The automatic paper feed tray 35 is disposed in a vertically lower part of the image forming apparatus 100 and in form of a container-shaped member for storing the recording mediums. Examples of the recording medium include plain paper, color copy paper, sheets for overhead projector, and postcards. The pickup roller 36 takes out sheet by sheet the recording mediums stored in the automatic paper feed tray 35, and feeds the recording mediums to a paper conveyance path S1. The conveying rollers 37 are a pair of roller members disposed in pressure-contact with each other, and convey the recording medium toward the registration rollers 38. The registration rollers 38 are a pair of roller members disposed in pressure-contact with each other, and feed to the transfer nip region the recording medium fed from the conveying rollers 37 in synchronization with the conveyance of the toner image borne on the intermediate transfer belt 25 to the transfer nip region. The manual paper feed tray 39 is a device for storing recording mediums so as to take the recording medium in the image forming apparatus 100, and the recording mediums stored in the manual paper feed tray 39 are different from the recording mediums stored in the automatic paper feed tray 35 and have any size. The recording medium taken in from the manual paper feed tray 39 passes through a paper conveyance path S2 by use of the conveying rollers 37, thereby being fed to the registration rollers 38. In the recording medium feeding section 5, the recording medium supplied sheet by sheet from the automatic paper feed tray 35 or the manual paper feed tray 39 is fed to the transfer nip region in synchronization with the conveyance of the toner image borne on the intermediate transfer belt 25 to the transfer nip region.

The discharging section 6 includes the conveying rollers 37, discharging rollers 40, and a catch tray 41. The conveying rollers 37 are disposed downstream of the fixing nip region along the paper conveyance direction, and convey toward the discharging rollers 40 the recording medium onto which the image has been fixed by the fixing section 4. The discharging rollers 40 discharge the recording medium onto which the image has been fixed, to the catch tray 41 disposed on a vertically upper surface of the image forming apparatus 100. The catch tray 41 stores the recording medium onto which the image has been fixed.

The image forming apparatus 100 includes a control unit (not shown). The control unit is disposed, for example, in an upper part of an internal space of the image forming apparatus 100, and contains a memory portion, a computing portion, and a control portion. To the memory portion of the control unit are input, for example, various set values obtained by way of an operation panel (not shown) disposed on the upper surface of the image farming apparatus 100, results detected from a sensor (not shown) etc. disposed in various portions inside the image forming apparatus 100, and image information obtained from external equipment. Further, programs for operating various functional elements are written. Examples of the various functional elements include a recording medium determining portion, an attachment amount controlling portion, and a fixing condition controlling portion. For the memory portion, those customarily used in the relevant filed can be used including, for example, a read only memory (ROM), a random access memory (RAM), and a hard disc drive (HDD). For the external equipment, it is possible to use electrical and electronic devices which can form or obtain the image information and which can be electrically connected to the image forming apparatus 100. Examples of the external equipment include a computer, a digital camera, a television, a video recorder, a DVD recorder, HDDVD, a Blu-ray disc recorder, a facsimile machine, and a mobile computer. The computing portion of the control unit takes out the various data (such as an image formation order, the detected result, and the image information) written in the memory portion and the programs for various functional elements, and then makes various determinations. The control portion of the control unit sends to a relevant device a control signal in accordance with the result determined by the computing portion, thus performing control on operations. The control portion and the computing portion include a processing circuit which is achieved by a microcomputer, a microprocessor, etc. having a central processing unit abbreviated as CPU). The control unit contains a main power source as well as the above-stated processing circuit. The power source supplies electricity to not only the control unit but also respective devices provided inside the image forming apparatus 100.

4. Fixing Device

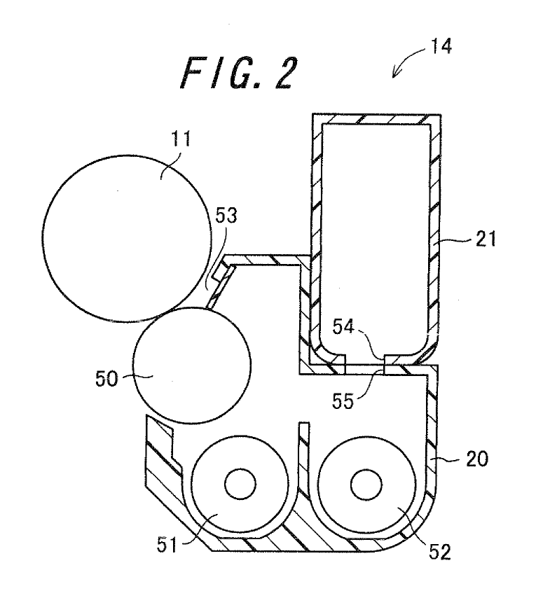

FIG. 2 is a schematic view schematically showing the developing device 14 provided in the image forming apparatus shown in FIG. 1. The developing device 14 comprises a developing tank 20 and a toner hopper 21. The developing tank 20 is a container-shaped member which is arranged so as to face the surface of a photoreceptor drum 11, feeds a toner to an electrostatic latent image formed on the surface of the photoreceptor drum 11 to develop the latent image, and forms a toner image as a visible image. The developing tank 20 has a toner in its inner space, has therein roller members such as a developing roller 50, a feed roller 51 and a stirring roller 52 and rotatably holds those members. Screw members may be provided in place of the roller-shaped members. The developing device 14 of the present embodiment has the toner which is the above-described one embodiment, as a toner in the developing tank 20.

An opening 53 is formed at a side facing the photoreceptor drum 11 of the developing tank 20, and the developing roller 50 is provided at a position facing the photoreceptor drum 11 through the opening 53 so as to rotatably drive. The developing roller 50 is a roller-shaped member which feeds a toner to an electrostatic latent image on the surface of the photoreceptor drum 11 in a press-contact region or a nearest region to the photoreceptor drum 11. In feeding the toner, potential opposite that of charge potential of a toner is applied to the surface of the developing roller 50 as developing bias voltage. This allows to smoothly feed the toner on the surface of the developing roller 50 to an electrostatic latent image. Furthermore, the amount of a toner fed to the electrostatic latent image, that is, the amount of a toner deposited on the electrostatic latent image, can be controlled by changing a developing bias value.

A feed roller 51 is a roller-shaped member provided facing the developing roller 50 so as to rotatably derive, and feeds a toner to the periphery of the developing roller 50.

A stirring roller 52 is a roller-shaped member provided facing the feed roller 51 so as to rotatably derive, and feeds a toner freshly fed to the developing tank 20 from the toner hopper 21 to the periphery of the feed roller 51. The toner hopper 21 is provided such that a toner replenishment port 54 provided at the lower part of the toner hopper 21 in a vertical direction is brought into communication with a toner reception port 55 provided at the upper part of the developing tank 20 in a vertical direction, and replenishes a toner according to consumption state of the toner in the developing tank 20. Alternatively, the toner hopper 21 may not be used and a toner may directly be supplied to developing tank 20 from a toner cartridge of each color.

As described above, the developing device 14 preferably develops a latent image using the developer of the invention. Because a latent image is developed using the developer of the invention, a high definition and high resolution toner image can stably be formed on the photoreceptor drum 11 without causing development defect due to decrease in toner specific charge. Therefore, a good image free of fogging can stably be formed on a non-image area over a long period of time.

According to the invention, it is preferable that the image forming apparatus 100 is implemented by comprising the photoreceptor drum 11 on which a latent image is formed, the charging section 12 which forms a latent image on the photoreceptor drum 11, the exposure unit 13, and the developing device 14 of the invention capable of forming a high definition toner image on the photoreceptor drum 11 as described above. By forming an image with the image forming apparatus 100, both of good cleanability and fixability can be achieved, and an image having high image quality free of fogging and free of decrease in image quality due to decrease in toner specific charge can stably be formed on a non-image area over a long period of time.

### EXAMPLES

Each of properties of toners in Examples and Comparative Examples was measured as follows.

### [Volume Average Particle Size of Toner]

To 50 ml of an electrolyte (trade name: ISOTON-II, manufactured by Beckman Coulter), 20 mg of a sample and 1 ml of sodium alkyl ether sulfuric acid ester were added, and the resulting mixture was dispersion-treated with an ultrasonic disperser (trade name: UH-50, manufactured by STM) at a ultrasonic wave frequency of 20 kHz for 3 minutes to prepare a measuring sample. The measuring sample was measured under the conditions of aperture diameter: 100 μm and the number of measuring particles: 50,000 counts using a particle size analyzer (trade name: Multisizer 3, manufactured by Beckman Coulter), and a volume average particle size was obtained from a volume particle size distribution of the sample particles.

[Glass Transition Temperature (Tg) of Binder Resin]

By using a differential scanning calorimeter (trade name: DSC 220, manufactured by Seiko Instruments & Electronics Ltd.), 1 g of the sample was heated at a rate of 10° C. a minute to measure a DSC curve thereof in compliance with the Japanese Industrial Standards (JIS) K 7121-1987. The glass transition temperature (Tg) was found from a temperature at a point where a straight line drawn by extending a base line on the high temperature side of the endothermic peak corresponding to the glass transition of the obtained DSC curve toward the low temperature side, intersected a tangential line drawn at a point where the gradient became a maximum with respect to a curve from a rising portion of peak to a vertex.

[Softening Temperature (Tm) of Binder Resin]

A rheological characteristics evaluation apparatus (trade name: Flow Tester CFT-100C manufactured by Shimadzu Corporation) was so set that 1 g of a sample was extruded from a die (nozzle, port size of 1 mm, length of 1 mm) under a load of 10 kgf/cm² (9.8×10⁵ Pa). The sample was heated at a heating rate of 6° C., a minute, and the temperature was found at a moment when half the amount of the sample has flown from the die, and was regarded to be a softening temperature.

[Melting Point of Release Agent]

By using a differential scanning calorimeter (trade name: DSC 220, manufactured by Seiko Instruments & Electronics Ltd.), 1 g of the sample was heated at a rate of 10° C. per minute from a temperature of 20° C. up to 200° C. and was, quickly cooled from 200° C. down to 20° C. This operation was repeated twice to measure a DSC curve. The temperature at a vertex of the endothermic peak corresponding to the melting of the DSC curve measured in the second operation was regarded to be the melting point of the release agent.

[Average Primary Particle Size of Silica Particles and Inorganic Fine Particles, and Geometric Standard Deviation σ_{g} of Particle Size of Silica Particles]

Regarding 1,000 silica particles, an image of each of silica particles enlarged 50,000 times was photographed with a scanning electron microscope (trade name: S-4300 SE/N, manufactured by Hitachi High-Technologies Corporation) by changing visual field of the scanning electron microscope, and particle sizes of primary particles of the silica particles were respectively measured by image analysis. A particle size distribution was obtained by calculating frequency ratio at an optional particle size from the measurement values obtained. Furthermore, an average primary particle size of the silica particles was calculated from particle size distribution data up to the number cumulative ratio exceeding 50%. An average primary particle size of the inorganic fine particles was similarly calculated. Furthermore, the geometric standard deviation σ_{g} was obtained from the data of the particle size of the silica particles and the number cumulative ratio by using number standard distribution function of a logarithmic normal distribution.

[Amount of Water in Silica Particles]

The amount of water in the silica particles was measured using Karl Fisher moisture meter (trade name: CA-100, manufactured by Mitsubishi Chemical Corporation). Heating temperature was set to 105° C.

[Coverage of Silica Particles to Toner Particle, and Coverage of Inorganic Fine Particles to Toner Particle]

Coverage of the silica particles to the toner particle shows a ratio of surface area of the silica particles present on the surface of the toner particle to surface area of the toner particle. The coverage of the silica particles y was calculated by substituting a volume average particle size D and absolute specific gravity pt of the toner particles, before mixing the toner particles and the silica particles, an average primary particle size d and absolute specific gravity ρi of the silica particles, and a ratio of the weight of the silica particles to the weight of the toner particles (weight of external additives/weight of toner matrix) C into the following expression (1). The coverage of the inorganic fine particles was similarly obtained.

$$y ( \% ) = \frac{\sqrt{3}}{2 π} \times \frac{D \cdot ρ t}{d \cdot ρ i} \times C \qquad ( 1 )$$

[Specific Gravity of Toner Particle and Silica Particle]

The present embodiment regards density as specific gravity. The density was measured using a specific surface area & pore size distribution analyzer (trade name: NOVAe 4200e, manufactured by Yuasa Ionics Inc.).

[Shape Factor of Toner Particle]

A metal film (Au film, film thickness: 0.5 μm) is formed by sputtering deposition. 200 to 300 particles are randomly extracted from covering particles of the metal film at an accelerating voltage of 5 kV and at 1,000-fold magnification by a scanning electron microscope (trade name: S-570, manufactured by Hitachi, Ltd.), and photographed. The data of the electron microphotograph is image-analyzed with an image analysis software (trade name: A-ZO-KUN, manufactured by Asahi Kasei Engineering Corporation). Particle analysis parameters of the image analysis software “A-ZO-KUN” are small graphic removal area: 100 pixels, shrinkage separation: one time, small graphic: 1, the number: 10, noise removing filter: none, shading: none, and result indicating unit: μm. The shape factor SF-1 and the shape factor SF-2 are obtained from maximum length MXLNG, peripheral length PERI and graphic area. AREA of non-spherical particles thus obtained by the following expressions (A) and (B).

Shape Factor SF-1={(MAXLNG)2/AREA}×(100π/4) (A)

Shape Factor SF-2={(PERI)2/AREA}×(100/4π) (B)

The shape factor SF-1 is a value represented by the above expression (A), and shows the degree of roundness of a shape of a particle. When the value of SF-1 is 100, the shape of a particle is a perfect sphere, and the shape becomes irregular with the increase of the value of SF-1. The shape factor SF-2 is a value represented by the above expression (B), and shows the degree of irregularity of surface shape of a particle. When the value of SF-2 is 100, irregularities are not present on the particle surface, and irregularities become remarkable with the increase of the value of SF-2.

[Specific Surface Area of Silica Particle]

Specific surface area was measured by BET three-point method in which gradient A is obtained from nitrogen absorption to 3 points of relative pressure using a specific surface area & pore size distribution analyzer (trade name: NOVAe 4200e, manufactured by Yuasa Ionics Inc.), and a specific surface value is obtained from BET equation.

(Production of Silica Particles A to D)

Silica particles A to B having properties shown in Table 1 were obtained by the conventional a gas phase method. The gas phase method is a method for producing silica particles by burning a silicon compound or metallic silicon in flame, for example, oxyhydrogen flame. Silicon tetrachloride is generally used as the silicon compound.

(Production of Silica Particles E to O)

Particles obtained by the conventional sol-gel method were heated to lose the weight until reaching the amount of water shown in Table 1, thereby obtaining silica particles E to O having properties shown in Table 1. The sol-gel method is a method for forming particles by subjecting alkoxysilane to hydrolysis and condensation reaction in the presence of a catalyst in an organic solvent in which water is present, thereby obtaining a silica sol suspension, and removing a solvent from the silica sol suspension, followed by drying.

An average primary particle size, an amount of water, geometric standard deviation and a specific surface area of the silica particles A to O are shown in Table 1.

TABLE 1

| Kind of | Average primary | Amount of | Geometric | Specific | |
|---|---|---|---|---|---|
| silica | particle size | water | standard | surface area | Hydrophobization |
| particle | (nm) | (%) | deviation | (m²/g) | treatment |
| A | 80 | 0.07 | 1.35 | 60 | Done |
| B | 90 | 0.12 | 1.37 | 40 | Done |
| C | 125 | 0.10 | 1.29 | 24 | Done |
| D | 150 | 0.25 | 1.33 | 20 | Done |
| E | 65 | 1.20 | 1.22 | 55 | Done |
| F | 85 | 1.00 | 1.21 | 40 | Done |
| G | 115 | 1.50 | 1.23 | 34 | Done |
| H | 150 | 1.50 | 1.24 | 30 | Done |
| I | 110 | 8.00 | 1.23 | 28 | Done |
| J | 175 | 1.50 | 1.27 | 12 | Done |
| K | 110 | 1.50 | 1.25 | 37 | None |
| L | 110 | 1.70 | 1.28 | 38 | Done |
| M | 75 | 1.15 | 1.22 | 50 | Done |
| N | 100 | 1.20 | 1.20 | 35 | Done |
| O | 155 | 1.25 | 1.23 | 25 | Done |

[Preconsideration]

At first, a preferred shape of toner particle was obtained by the preconsideration.

[Preconsideration Example 1 of Toner]

### [Production of Toner Particles]

With Henschel mixer, 79 parts by weight of a polyester (glass transition temperature (Tg): 63.8° C., Mw=82,000) as a binder resin, 16 parts by weight of a masterbatch (containing 40% by weight of C.I. Pigment Blue 15:3), 4 parts by weight of a paraffin wax (release agent, trade name: HNP 11, manufactured by Nippon Seiro Co., Ltd., melting point: 68° C.), and 1 part by weight of an alkyl salicyclic acid metal salt (charge control agent, trade name: BONTRON E-84, manufactured by Orient Chemical Industries, Ltd.) were mixed for 10 minutes. The resulting mixture was melt-kneaded using a twin-screw extruder (trade name: PCM65, manufactured by Ikegai Ltd.). Thus, a melt-kneaded product was obtained.

Into PUC Colloid Mill (trade name, manufactured by Nippon Ball Valve Co., Ltd.), 900 parts by weight of the melt-kneaded product were introduced together with 120 parts by weight of an anionic dispersant (polyacrylic acid: abbreviation PPA, trade name: NEWCOL 10N (solid content concentration 25.8%), manufactured by Nippon Nyukazai Co., Ltd.), 2 parts by weight of a wetting agent (trade name: AIR ROLL (solid content concentration 72.0%), manufactured by Toho Chemical Industry Co., Ltd.) and 1,978 parts by weight of ion-exchanged water, and the resulting mixture was wet-ground to obtain a coarse powder slurry of the melt-kneaded product.

The melt-kneaded product contained in the coarse powder slurry of the melt-kneaded product was pulverized with a high-pressure homogenizer Nano 3000 under the following pulverization conditions to form fine particles, followed by cooling and reducing pressure. Thus, a slurry of melt-kneaded product particles (liquid temperature: 30° C.) was obtained.

<Pulverization Conditions>

Pressure: 167 MPa

Preset temperature: 190 (softening temperature of melt-kneaded product +71.4)° C.

Nozzle size: 0.07 mm

To 600 parts by weight of the slurry of the melt-kneaded product particles, 22.2 parts by weight of a coagulant (primary sodium chloride, manufactured by Wako Pure Chemical Industries, Ltd.) were added, and the melt-kneaded product particles contained in the slurry of the melt-kneaded product particles were coagulated using CLAIR MIX N MOTION under the following coagulation conditions. Thus, an aqueous dispersion of toner particles was prepared. Content concentration of the coagulant was calculated as a fraction in terms of post-addition of the toner particles to the slurry. For example, when 22.2 parts by weight of the coagulant were added to 600 parts by weight of the slurry of the melt-kneaded product particles, the coagulant concentration was calculated as (22.2/600)×100=3.70(%). The calculation of such a coagulant concentration is the same even in Examples and Comparative Examples described hereinafter.

<Coagulation Conditions>

Reaching temperature: 62° C.

Temperature-rising rate: 1.5° C./min

Holding time at preset temperature: 10 minutes

Number of revolution (rotor/stator): 18,000 rpm/0 rpm

Power corresponding to shear force: 184 W

An aqueous dispersion of the toner particles obtained was sufficiently washed with ion-exchanged waster, followed by drying. Thus, toner particles having a volume average particle size of 6 μm, a shape factor SF-1 of 120 and a shape factor SF-2 of 110 were prepared. 1.2 parts by weight of silica fine particles (trade name: RX200, manufactured by Degussa Co., Ltd.) as inorganic fine particles were externally added to 100 parts by weight of the toner particles, and 1.0 part by weight of silica particles I was then externally added thereto. Thus, a toner of preconsideration example 1 was obtained.

(Preconsideration Examples 2 to 16 of Toner)

Toners of preconsideration examples 2 to 16 were obtained in the same manner as in the preconsideration example 1 except for using the toner particles thus obtained in place of the toner particles used in the preconsideration example 1, in which toner particles having a volume average particle size of 6 μm and shape factors shown in Table 2 were prepared by the production method of toner particles as described before, respectively.

In the preconsideration examples 1 to 16, inorganic fine particles having a particle size smaller than that of silica particles I were externally added to the toner particles before externally adding the silica particles I to the surface of the toner particles. In this case, the coverage of the inorganic fine particles to the surface of the toner particles was fixed to 90%. Furthermore, the coverage of the silica particles was fixed to 10%. Specific gravity (density) of the toner particle is 1.2, and specific gravity (density) of the silica particle is 2.2. Volume average particle size of the inorganic fine particles is 12 nm, and specific gravity (density) thereof is 2.2.

Shape of the toner particles used in the preconsideration examples 1 to 16, and kind and additive amount of the silica particles are shown in Table 2.

TABLE 2

| | Toner particle | | Silica particle | |
|---|---|---|---|---|
| | Shape factor | Shape factor | | Additive amount |
| | SF-1 | SF-2 | Kind | (parts by weight) |
| Preconsideration | 120 | 110 | I | 1 |
| example 1 | | | | |
| Preconsideration | 130 | 110 | I | 1 |
| example 2 | | | | |
| Preconsideration | 140 | 110 | I | 1 |
| example 3 | | | | |
| Preconsideration | 150 | 110 | I | 1 |
| example 4 | | | | |
| Preconsideration | 120 | 120 | I | 1 |
| example 5 | | | | |
| Preconsideration | 130 | 120 | I | 1 |
| example 6 | | | | |
| Preconsideration | 140 | 120 | I | 1 |
| example 7 | | | | |
| Preconsideration | 150 | 120 | I | 1 |
| example 8 | | | | |
| Preconsideration | 120 | 130 | I | 1 |
| example 9 | | | | |
| Preconsideration | 130 | 130 | I | 1 |
| example 10 | | | | |
| Preconsideration | 140 | 130 | I | 1 |
| example 11 | | | | |
| Preconsideration | 150 | 130 | I | 1 |
| example 12 | | | | |
| Preconsideration | 120 | 140 | I | 1 |
| example 13 | | | | |
| Preconsideration | 130 | 140 | I | 1 |
| example 14 | | | | |
| Preconsideration | 140 | 140 | I | 1 |
| example 15 | | | | |
| Preconsideration | 150 | 140 | I | 1 |
| example 16 | | | | |

Ferrite core carrier having a volume average particle size of 45 μm was used as a carrier. The carrier and each of the toners of the preconsideration examples 1 to 16 were mixed with V-type mixer (trade name: V-5, manufactured by Tokuju Corporation) for 40 minutes such that the coverage of each toner to the carrier is 60%. Thus, two-component developers of the preconsideration examples 1 to 16 were prepared.

Using those two-component developers, transfer efficiency and cleanability were evaluated by the following methods.

[Transfer Efficiency]

The transfer efficiency is the ratio of the toner transferred onto the intermediate transfer belt from the surface of the photoreceptor drum in the primary transfer, and is calculated with the amount of toner present on the photoreceptor drum before the transfer as 100%. The toner present on the photoreceptor drum before the transfer was sucked by using a device for measuring the amount of electric charge (trade name: MODEL 210HS-2A, manufactured by TREK JAPAN K.K.), and the transfer efficiency was found by measuring the amount of the sucked toner. The amount of toner transferred onto the intermediate transfer belt was also similarly found.

The evaluation was made on the following basis.

Excellent: Very favorable. The transfer efficiency was not smaller than 95%.

Good: Favorable. The transfer efficiency was not smaller than 90% but was smaller than 95%.

Not Bad: No problem in practical use. The transfer efficiency was not smaller than 85% but was smaller than 90%.

Poor: Practically unusable. The transfer efficiency was smaller than 85%.

[Cleanability]

The pressure of a cleaning blade was adjusted to be 25 gf/cm (2.45×10⁻¹ N/cm) in terms of the initial line pressure, the pressure of the cleaning blade being the pressure with which the cleaning blade of cleaning unit of the commercially available copying machine (trade name: MX-3500, manufactured by Sharp Corporation) is brought into contact with the photoreceptor drum. The copying machine was charged with the two-component developers containing the toners obtained in the preconsideration examples 1 to 16, and a character test chart manufactured by Sharp Corporation. was formed on 10,000 pieces of the recording paper in an environment of an ordinary temperature and an ordinary humidity, i.e., a temperature of 25° C. and a relative humidity of 50%.

The cleanability was evaluated by confirming the formed images by eyes, i.e., by testing the vividness at the boundary portion between the image portion and the non-image portion and the presence of black stripes formed by the leakage of toner in the direction in which the photoreceptor drum rotates, in each of the stages of prior to forming the image (initial stage), after having printed 5,000 pieces (5K pieces) and after having printed 10,000 pieces (20K pieces). Further, the fogging amount Wk was found by using a measuring instrument that will be described later, and cleanability was evaluated using the value.

The fogging amount Wk of the formed image was found as described below by measuring the reflection density by using a color difference meter (trade name: Z-Σ90 COLOR MEASURING SYSTEM, manufactured by Nippon Denshoku Industries Co., Ltd.) That is, the average reflection density Wr of the recording paper was measured, first, prior to forming the image. Next, the image was formed by the recording portion and after the image was formed, the reflection density was measured on various white portions of the recorded paper. From the portion decided to be most fogging, i.e., from the reflection density Ws of the most dense portion despite of the white portion and from the above average reflection density Wr, a value found in compliance with the following expression (2) was defined to be the fogging amount Wk (%).

Wk=100×(Ws−Wr)/Wr (2)

The evaluation was made on the following basis.

Excellent: Very favorable. Highly vivid, no black stripe, and the fogging amount Wk is less than 3%.

Good: Favorable. Highly vivid, no black stripe, and the fogging amount Wk is not less than 3% but is less than 5%.

Not Bad: No problem in practical use. Practically, vividness is without problem. Black stripes are not longer than 2.0 mm, its number is not more than 5, and the fogging amount Wk is not less than 5% but is less than 10%.

Poor: Practically unusable. Practicably, vividness is poor. Either the black stripes are not shorter than 2.0 mm or its number is not less than 6. The fogging amount Wk is not less than 10%.

Evaluation results for transfer efficiency and cleanability are shown in Table 3.

TABLE 3

| | | | Cleanability | | | | |
|---|---|---|---|---|---|---|---|
| | Transfer efficiency | | | | | Amount | |
| | Transfer | | | | | of fog | |
| | efficiency | | | Black stripe | | Wk | |
| | (%) | Evaluation | Vividness | Length | Number | (%) | Evaluation |
| Preconsideration example 1 | 97 | Excellent | Practically unusable | 10 mm or more | 20 or more | 12 | Poor |
| Preconsideration example 2 | 96 | Excellent | Practically unusable | 10 mm or more | 20 or more | 11.5 | Poor |
| Preconsideration example 3 | 95 | Excellent | Practically unusable | 5-10 mm | 5 or less | 10.5 | Poor |
| Preconsideration example 4 | 91 | Good | No problem in practical use | 2 mm or less | 3 | 9.8 | Not Bad |
| Preconsideration example 5 | 96 | Excellent | Practically unusable | 5-10 mm | 10 | 10.5 | Poor |
| Preconsideration example 6 | 97 | Excellent | Favorable | No black stripe | | 1.8 | Excellent |
| Preconsideration example 7 | 96 | Excellent | Favorable | No black stripe | | 1.9 | Excellent |
| Preconsideration example 8 | 93 | Good | Favorable | No black stripe | | 1.2 | Excellent |
| Preconsideration example 9 | 97 | Excellent | Practically unusable | 5-10 mm | 5 or less | 10.2 | Poor |
| Preconsideration example 10 | 98 | Excellent | Favorable | No black stripe | | 1.6 | Excellent |
| Preconsideration example 11 | 97 | Excellent | Favorable | No black stripe | | 1.4 | Excellent |
| Preconsideration example 12 | 93 | Good | Favorable | No black stripe | | 1.1 | Excellent |
| Preconsideration example 13 | 92 | Good | Practically unusable | 5-10 mm | 5 or less | 11.5 | Poor |

| | | | | | | |
|---|---|---|---|---|---|---|
| Preconsideration example 14 | 92 | Good | Favorable | No black stripe | 1.5 | Excellent |
| Preconsideration example 15 | 91 | Good | Favorable | No black stripe | 1.4 | Excellent |
| Preconsideration example 16 | 89 | Not Bad | Favorable | No black stripe | 1.2 | Excellent |

It is seen from the above results that the toner particle shape having the shape factor SF-1 of 130 or more and 140 or less and the shape factor SF-2 of 120 or more and 130 or less can establish both of good transfer efficiency and cleanability, and is therefore optimum. When the shape factor SF-1 which judges a shape of toner particle is 120, the shape of the toner particle is close to a perfect sphere, and therefore, cleaning defect is easily generated. Furthermore, when the shape factor SF-2 is 150, transfer efficiency is decreased. Although the detailed cause is not clear, it is considered that decrease in the closest packing rate among toners is the cause.

In the shape factor SF-2 which judges irregularity state on the surface of the toner particle, when the shape factor SF-2 is 110 in which the shape of the toner particle is smooth, decrease in cleanability is confirmed. This is considered due to that because irregular portions on the surface of the toner particle were few, adhesion of the silica particle was decreased. Furthermore, when the shape factor SF-2 is large as 140, decrease in transfer efficiency is confirmed. This is considered due to that silica particles entered depressed portions on the surface of the toner particle, and spacer effect was not exhibited. The transfer step is conducted at the upstream side of the cleaning step. Therefore, it was possible to measure transfer efficiency even in a toner occurring cleaning defect.

Examples and Comparative Examples were carried out on the basis of the results of the above preconsideration examples.

(Production of Toner Particles a)

Toner particles having the shape factor SF-1 of 130 and the shape factor SF-2 of 120 were prepared by the production method of the toner particles as described above, and toner particles having a small size were classified and removed from the toner particles by a rotary classifier. Thus, toner particles a having a volume average particle size of 4.5 μm were obtained. Even though the classification is conducted, the shape factor of the toner particles remain unchanged as compared with that before classification.

(Production of Toner Particles b to e)

Toner particles b to e having the respective volume average particle sizes shown in Table 4 were obtained in the same manner as the production method of the toner particles a except for changing the classification conditions.

The shape factor and volume average particle size of the toner particles a to e are shown in Table 4.

TABLE 4

| | Shape factor | Shape factor | Volume average particle |
|---|---|---|---|
| Toner particle | SF-1 | SF-2 | size (μm) |
| a | 130 | 120 | 4.5 |
| b | 130 | 120 | 5 |
| c | 130 | 120 | 6 |
| d | 130 | 120 | 7 |
| e | 130 | 120 | 7.5 |

### Example 1

To 100 parts by weight of the toner particles b, 1.45 parts by weight of silica fine particles (trade name: RX200, manufactured by Degussa AG) as inorganic fine particles were externally added, and 1.2 parts by weight of the silica particles F were then externally added. Thus, a toner of Example 1 was obtained.

### Example 2

A toner of Example 2 was obtained in the same manner as in Example 1, except for externally adding 1.6 parts by weight of the silica particles G in place of the silica particle F.

### Example 3

A toner of Example 3 was obtained in the same manner as in Example 1, except for externally adding 2.0 parts by weight of the silica particles H in place of the silica particle F.

### Example 4

A toner of Example 4 was obtained in the same manner as in Example 1, except that toner particles c were used in place of the toner particles b, the amount of the silica fine particles was changed from 1.45 parts by weight to 1.2 parts by weight, and the amount of the silica particles F was changed from 1.2 parts by weight to 1.0 part by weight.

### Example 5

A toner of Example 5 was obtained in the same manner as in Example 4, except for externally adding 1.3 parts by weight of the silica particles G in place of the silica particles F.

### Example 6

A toner of Example 6 was obtained in the same manner as in Example 1, except for externally adding 3.0 parts by weight of the silica particles H in place of the silica particles F.

### Example 7

To 100 parts by weight of the toner particles d, 1.15 parts by weight of silica fine particles (trade name: RX200, manufactured by Degussa AG) were externally added, and 1.0 part by weight of the silica particles F were then externally added. Thus, a toner of Example 7 was obtained.

### Example 8

A toner of Example 8 was obtained in the same manner as in Example 7, except for externally adding 1.1 parts by weight of the silica particles G in place of the silica particles F.

### Example 9

A toner of Example 9 was obtained in the same manner as in Example 7, except for externally adding 1.5 parts by weight of the silica particles H in place of the silica particles F.

### Example 10

A toner of Example 10 was obtained in the same manner as in Example 7, except for externally adding 1.1 parts by weight of the silica particles K in place of the silica particles F.

### Example 11

A toner of Example 11 was obtained in the same manner as in Example 4, except for externally adding 1.4 parts by weight of the silica particles C in place of the silica particles F.

### Example 12

To 100 parts by weight of the toner particles e, 0.96 part by weight of silica fine particles (trade name: RX200, manufactured by Degussa AG) were externally added, and 1.05 parts by weight of the silica particles G were then externally added. Thus, a toner of Example 12 was obtained.

### Example 13

A toner of Example 13 was obtained in the same manner as in Example 4, except for externally adding 1.11 parts by weight of the silica particles N in place of the silica particles F.

### Comparative Example 1

To 100 parts by weight of the toner particles a, 1.6 parts by weight of silica fine particles (trade name: RX200, manufactured by Degussa AG) were externally added, and 1.7 parts by weight of the silica particles G were then externally added. Thus, a toner of Comparative Example 1 was obtained.

### Comparative Example 2

A toner of Comparative Example 2 was obtained in the same manner as in Comparative Example 1, except that toner particles c were used in place of the toner particles a, the amount of the silica fine particles was changed from 1.6 parts by weight to 1.2 parts by weight, and 0.9 part by weight of the silica particles A were externally added in place of the silica particles G.

### Comparative Example 3

A toner of Comparative Example 3 was obtained in the same manner as in Comparative Example 2, except for externally adding 1.0 part by weight of the silica particles B in place of the silica particles A.

### Comparative Example 4

A toner of Comparative Example 4 was obtained in the same manner as in Comparative Example 2, except for externally adding 1.7 parts by weight of the silica particles D in place of the silica particles A.

### Comparative Example 5

A toner of Comparative Example 5 was obtained in the same manner as in Comparative Example 2, except for externally adding 0.75 part by weight of the silica particles E in place of the silica particles A.

### Comparative Example 6

A toner of Comparative Example 6 was obtained in the same manner as in Comparative Example 2, except for externally adding 1.25 parts by weight of the silica particles I in place of the silica particles A.

### Comparative Example 7

A toner of Comparative Example 7 was obtained in the same manner as in Comparative Example 2, except for externally adding 2.0 parts by weight of the silica particles J in place of the silica particles A.

### Comparative Example 8

A toner of Comparative Example 8 was tried to obtain in the same manner as in Example 5 except that the silica fine particles were not externally added. However, the silica particles G could not uniformly be dispersed on the surface of the toner particles c, and fluidity of a toner could not be secured. As a result, a toner that can be subjected to performance verification could not be obtained.

### Comparative Example 9

A toner of Comparative Example 9 was obtained in the same manner as in Comparative Example 2, except for externally adding 1.22 parts by weight of the silica particles L in place of the silica particles A.

### Comparative Example 10

A toner of Comparative Example 10 was obtained in the same manner as in Comparative Example 2, except for externally adding 0.83 part by weight of the silica particles M in place of the silica particles A.

### Comparative Example 11

A toner of Comparative Example 11 was obtained in the same manner as in Comparative Example 2, except for externally adding 1.72 parts by weight of the silica particles O in place of the silica particles A.

Properties of the toners obtained in Examples 1 to 13 and Comparative Examples 1 to 11 are shown in Table 5.

TABLE 5

| | | | | | Inorganic fine |
|---|---|---|---|---|---|
| | Toner | Silica particle | | | particle |
| | particle | | Additive amount | Hydrophobization | Additive amount |
| | Kind | Kind | (parts by weight) | treatment | (parts by weight) |
| Example 1 | b | F | 1.2 | Done | 1.45 |
| Example 2 | b | G | 1.6 | Done | 1.45 |
| Example 3 | b | H | 2.0 | Done | 1.45 |
| Example 4 | c | F | 1.0 | Done | 1.2 |
| Example 5 | c | G | 1.3 | Done | 1.2 |
| Example 6 | b | H | 3.0 | Done | 1.2 |
| Example 7 | d | F | 1.0 | Done | 1.15 |
| Example 8 | d | G | 1.1 | Done | 1.15 |
| Example 9 | d | H | 1.5 | Done | 1.15 |
| Example 10 | d | K | 1.1 | None | 1.15 |
| Example 11 | c | C | 1.4 | Done | 1.2 |
| Example 12 | e | G | 1.05 | Done | 0.96 |
| Example 13 | c | N | 1.11 | Done | 1.2 |
| Comparative | a | G | 1.7 | Done | 1.6 |
| Example 1 | | | | | |
| Comparative | c | A | 0.9 | Done | 1.2 |
| Example 2 | | | | | |
| Comparative | c | B | 1.0 | Done | 1.2 |
| Example 3 | | | | | |
| Comparative | c | D | 1.7 | Done | 1.2 |
| Example 4 | | | | | |
| Comparative | c | E | 0.75 | Done | 1.2 |
| Example 5 | | | | | |
| Comparative | c | I | 1.25 | Done | 1.2 |
| Example 6 | | | | | |
| Comparative | c | J | 2.0 | Done | 1.2 |
| Example 7 | | | | | |
| Comparative | c | G | 1.3 | Done | — |
| Example 8 | | | | | |
| Comparative | c | L | 1.22 | Done | 1.2 |
| Example 9 | | | | | |
| Comparative | c | M | 0.83 | Done | 1.2 |
| Example 10 | | | | | |
| Comparative | c | O | 1.72 | Done | 1.2 |
| Example 11 | | | | | |

Ferrite core carrier having a volume average particle size of 45 μm was used as a carrier. The carrier and each of the toners of Examples 1 to 13 and Comparative Examples 1 to 11 were mixed with V-type mixer (trade name: V-5, manufactured by Tokuju Kosakusho Co., Ltd.) for 40 minutes such that the coverage of each toner to the carrier is 60%. Thus, two-component developers of Examples 1 to 13 and Comparative Examples 1 to 11 were prepared.

Using the two-component developers of Examples 1 to 13 and Comparative Examples 1 to 11, transfer efficiency, cleanability, void and resolution were evaluated by the following methods, and using the toners of Examples 1 to 13 and Comparative Examples 1 to 11, charge stability was evaluated by the following method.

[Transfer Efficiency]

Transfer efficiency was evaluated by the same method as the evaluation method of transfer efficiency of the preconsideration examples 1 to 16.

[Cleanability]

Cleanability was evaluated by the same method as the evaluation method of cleanability of the preconsideration examples 1 to 16.

[Void]

The two-component developer was charged in the commercially available copying machine (trade name: MX-3500, manufactured by Sharp Corporation), the deposition amount was adjusted to be 0.4 mg/cm², and an image of 3×5 isolated dots was formed. The image of 3×5 isolated dots is an image formed such that a distance is 5 dots between the adjacent dots in plural dot portions having a size of 3 dots in vertical and 3 dots in horizontal in 600 dpi (dot per inch). The image formed was enlarged 100 times with a microscope (manufactured by Keyence Corporation) and displayed on a monitor. The number of voids generated in 70 3×5 isolated dots was confirmed.

The evaluation standards were as follows.

Excellent: Very Favorable. The number of voids generated was from 0 to 3.

Good: Favorable. The number of voids generated was from 4 to 6.

Not Bad: No problem in practical use. The number of voids generated was from 7 to 10.

Poor: Practically unusable. The number of voids generated was 11 or more.

[Resolution]

In the copying machine, a halftone image having image density of 0.3 and a size of 5 mm was adjusted to the condition capable of copying in image density of from 0.3 to 0.5. A manuscript on which an original image of a fine line having exactly a line width of 100 μm was copied, and a copied image obtained was used as a measuring sample. A line width of the line formed on the measuring sample was measured by an indicator from a monitor image obtained by enlarging the measuring sample 100 times using a particle analyzer (trade name: LUZEX 450, manufactured by Nireco Corporation). Image density is an optical reflection density measured with a reflective densitometer (trade name: RD-918, manufactured by Macbeth Corporation). Irregularities are present on the fine line, and line width differs depending on measurement position. Therefore, the line width was measured at plural measurement positions, the values obtained were averaged, and the average value was used as a line width of the measuring sample. The line width of the measuring sample was divided by 100 μm as a line width of a manuscript, and the value obtained was multiplied by 100. Such a value was obtained as a value of reproducibility of a fine line. Reproducibility of a fine line is good as the value of reproducibility of a fine line is close to 100, showing excellent resolution. In this case, a line width less than 100 μm due to transfer defect or the like was not counted, and a value of a line width less than 100 μn was not used in calculating an average value of a line width.

Evaluation standards were as follows.

Excellent: Very favorable. A value of fine line reproducibility was 100 or more and less than 105.

Good: Favorable. A value of fine line reproducibility was 105 or more and less than 115.

Not Bad: No problem in practical use. A value of fine line reproducibility was 115 or more and 125 or less.

Poor: Practically unusable. A value of fine line reproducibility exceeded 125.

[Charge Stability]

With 95 parts by weight of ferrite core carrier having a volume average particle size of 45 μm, 5 parts by weight of each of the toners of Examples 1 to 13 and Comparative Examples 1 to 11 were mixed, and the resulting mixture was stirred with a portable ball mill (manufactured by Tokyo Glass Kikai Kabushiki Kaisha) for 30 minutes in an ordinary temperature and ordinary pressure environment at a temperature of 25° C. and a relative humidity of 50%, and initial charged amount of a toner was measured. A text chart having a printing ratio of 5% was printed 10,000 (10K) sheets with a two-component developer containing each of the toners of Examples 1 to 9 and Comparative Examples 1 to 9 by the commercially available copying machine (trade name: MX-3500, manufactured by Sharp Corporation), and the charged amount of the toner was measured.

The charged amount of a toner was measured using an electrostatic measurement instrument (210HS-2A, manufactured by TREK JAPAN K.K.) as follows. A mixture of ferrite particles and toner, collected from the ball mill was placed in a metal-made container equipped with a 795-mesh conductive screen at the bottom, only the toner was sucked with a suction machine under a suction pressure of 250 mmHg, and the charged amount of a toner was obtained from weight difference between weight of the mixture before suction and weight of the mixture after suction, and potential difference between capacitor polar plates connected to the container. The initial charged amount of a toner was Qᵢₙᵢ, the charged amount of a toner after printing 10K sheets was Q, and damping rate of the charged amount of a toner was obtained using the following expression (3). The charged amount of a toner is stable with a decrease of the damping rate.

Damping rate of charged amount of toner

=100×{(Q−Qᵢₙᵢ)/Qᵢₙᵢ} (3)

Evaluation standards were as follows.

Excellent: Very favorable. Damping rate of the charged amount was less than 5%.

Good: Favorable. Damping rate of the charged amount was 5% or more and less than 10%.

Not Bad: Damping rate of the charged amount was 10% or more and less than 15%.

Poor: Damping rate of the charged amount was 15% or more.

[Comprehensive Evaluation]

Comprehensive evaluation standards were as follows.

Excellent: Very favorable. “Not Bad” and “Poor” were not present in the evaluation results of cleanability, charge stability, void, resolution and transfer efficiency.

Good: Favorable. “Poor” was not present in the evaluation results of cleanability, charge stability, void, resolution and transfer efficiency, and one to three “Not Bad” were present.

Not Bad: No problem in practical use. “Poor” was not present in the evaluation results of cleanability, charge stability, void, resolution and transfer efficiency, and four or more “Not Bad” were present.

Poor: No Good. “Poor” was present in the evaluation results of cleanability, charge stability, void, resolution and transfer efficiency.

Evaluation results of the toners of Examples 1 to 13 and Comparative Examples 1 to 11 and comprehensive results are shown in Table 6.

TABLE 6

| | Transfer efficiency | | Cleanability | | | | |
|---|---|---|---|---|---|---|---|
| | Transfer | | | | | Amount of fog | |
| | efficiency | | | Black stripe | | Wk | |
| | (%) | Evaluation | Vividness | Length | Number | (%) | Evaluation |
| Example 1 | 97 | Excellent | Favourable | No black stripe | | 2.0 | Excellent |
| Example 2 | 96 | Excellent | Very favourable | No black stripe | | 2.5 | Excellent |
| Example 3 | 93 | Good | Favourable | No black stripe | | 3.1 | Good |
| Example 4 | 97 | Excellent | Very favourable | No black stripe | | 2.0 | Excellent |
| Example 5 | 94 | Good | Favourable | No black stripe | | 1.9 | Excellent |
| Example 6 | 94 | Good | Favourable | No black stripe | | 2.1 | Excellent |
| Example 7 | 97 | Excellent | Favourable | No black stripe | | 2.2 | Excellent |
| Example 8 | 93 | Good | Favourable | No black stripe | | 1.8 | Excellent |
| Example 9 | 92 | Good | Favourable | No black stripe | | 2.3 | Excellent |
| Example 10 | 96 | Excellent | Favourable | No black stripe | | 2.5 | Excellent |
| Example 11 | 89 | Not Bad | Favourable | No black stripe | | 4.5 | Good |
| Example 12 | 94 | Good | Very favourable | No black stripe | | 2.5 | Excellent |
| Example 13 | 95 | Excellent | Favourable | No black stripe | | 2.1 | Excellent |
| Comparative Example 1 | 96 | Excellent | Favourable | 2-5 mm | 20 or more | 3.1 | Poor |
| Comparative Example 2 | 88 | Not Bad | No Good | No black stripe | | 12.0 | Poor |
| Comparative Example 3 | 88 | Not Bad | No Good | No black stripe | | 13.0 | Poor |
| Comparative Example 4 | 87 | Not Bad | No Good | No black stripe | | 12.5 | Poor |
| Comparative Example 5 | 89 | Not Bad | No Good | 2-5 mm | 20 or more | 15.0 | Poor |

| | | | | | | |
|---|---|---|---|---|---|---|
| Comparative Example 6 | 94 | Good | Favourable | No black stripe | 2.0 | Excellent |
| Comparative Example 7 | 92 | Good | Favourable | No black stripe | 3.2 | Good |
| Comparative Example 8 | — | — | — | — | — | — |
| Comparative Example 9 | 93 | Good | Favourable | No black stripe | 3.5 | Good |
| Comparative Example 10 | 88 | Not Bad | No Good | No black stripe | 10.5 | Poor |
| Comparative Example 11 | 93 | Good | Favourable | No black stripe | 3.3 | Good |

| | | | | | Charge stability | | |
|---|---|---|---|---|---|---|---|
| | | | Resolution | | Damping rate of | | |
| | Void | | Value of fine line | | charged amount | | Comprehensive |
| | Number | Evaluation | reproducibility | Evaluation | (%) | Evaluation | evalution |
| Example 1 | 2 | Excellent | 105 | Good | 3.9 | Excellent | Excellent |
| Example 2 | 2 | Excellent | 106 | Good | 4.7 | Excellent | Excellent |
| Example 3 | 4 | Good | 105 | Good | 4.5 | Excellent | Excellent |
| Example 4 | 3 | Excellent | 103 | Excellent | 4.5 | Excellent | Excellent |
| Example 5 | 2 | Excellent | 104 | Excellent | 5.0 | Good | Excellent |
| Example 6 | 5 | Good | 106 | Good | 5.2 | Good | Excellent |
| Example 7 | 3 | Excellent | 104 | Excellent | 4.7 | Excellent | Excellent |
| Example 8 | 5 | Good | 105 | Good | 4.7 | Excellent | Excellent |
| Example 9 | 4 | Good | 106 | Good | 4.8 | Excellent | Excellent |
| Example 10 | 10 | Not Bad | 125 | Not Bad | 14.5 | Not Bad | Good |
| Example 11 | 8 | Not Bad | 120 | Not Bad | 11.0 | Not Bad | Not Bad |
| Example 12 | 9 | Not Bad | 124 | Not Bad | 4.3 | Excellent | Good |
| Example 13 | 2 | Excellent | 105 | Good | 4.5 | Excellent | Excellent |
| Comparative Example 1 | 3 | Excellent | 104 | Excellent | 4.8 | Excellent | Poor |
| Comparative Example 2 | 10 | Not Bad | 126 | Poor | 4.8 | Excellent | Poor |
| Comparative Example 3 | 10 | Not Bad | 125 | Not Bad | 4.6 | Excellent | Poor |
| Comparative Example 4 | 8 | Not Bad | 124 | Not Bad | 4.5 | Excellent | Poor |
| Comparative Example 5 | 9 | Not Bad | 123 | Not Bad | 4.2 | Excellent | Poor |
| Comparative Example 6 | 5 | Good | 105 | Good | 17.8 | Poor | Poor |
| Comparative Example 7 | 6 | Good | 107 | Good | 19.8 | Poor | Poor |
| Comparative Example 8 | — | — | — | — | — | — | — |
| Comparative Example 9 | 5 | Good | 124 | Not Bad | 15.6 | Poor | Poor |
| Comparative Example 10 | 10 | Not Bad | 126 | Poor | 4.5 | Excellent | Poor |
| Comparative Example 11 | 2 | Good | 108 | Good | 15.6 | Poor | Poor |

As shown in Table 6, the toner of the invention is excellent in transfer efficiency, cleanability, resolution and toner discharge stability, and does not generate void. Therefore, the toner is useful in image quality stability. However, in Example 10, hydrophobization treatment was not applied to the silica particles. As a result, charge stability was slightly decreased, and void was slightly generated. In Example 11, specific surface area of the silica particles is relatively small. As a result, transfer efficiency, resolution and charge stability were slightly decreased, and void was slightly generated. In Example 12, the amount of the inorganic fine particles added is relatively small as being less than 1.0 part by weight. As a result, resolution was slightly decreased, and void was slightly generated.

In the present Examples, a magenta toner was exemplified as a toner. The reason for this is that C.I. Pigment Red 57:1 is contained as a colorant in magenta. However, the present embodiment can similarly be carried out by containing various colorants exemplified before in place of the colorant.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A toner comprising toner particles; and silica particles and inorganic fine particles that are externally added to the toner particles, the inorganic fine particles having an average primary particle size smaller than that of the silica particles,
the toner particles having a shape factor SF-1 of 130 or more and 140 or less, a shape factor SF-2 of 120 or more and 130 or less, and a volume average particle size of 5 μm or more and 8 μm or less;
the silica particles having an average primary particle size of 80 nm or more and 150 nm or less, and the amount of water of 1.5% by weight or less; and
a particle size distribution of the silica particles being a logarithmic normal distribution, and a value of geometric standard deviation σ_{g} of the particle size of the silica particles being less than 1.30.

2. The toner of claim 1, wherein the silica particles are subjected to hydrophobization treatment.

3. The toner of claim 1, wherein the silica particle has a specific surface area of 30 m²/g or more and 55 m²/g or less.

4. The toner of claim 1, wherein the silica particles are externally added in a proportion of 0.5 part by weight or more and 3.0 parts by weight or less based on 100 parts by weight of the toner particles.

5. A developer comprising the toner of claim 1.

6. The developer of claim 5, further comprising a carrier, the developer constituting a two-component developer.

7. A developing device which carries out development using the developer of claim 5.

8. A developing device which carries out development using the developer of claim 6.

9. An image forming apparatus comprising:
an image bearing member on which a latent image is to be formed;
a latent image forming section for forming a latent image on the image bearing member; and
the developing device of claim 7.

10. An image forming apparatus comprising:
an image bearing member on which a latent image is to be formed;
a latent image forming section for forming a latent image on the image bearing member; and
the developing device of claim 8.
